(19) United States
(12) Patent Application Publication
(10) Pub. No.: US 2026/0119980 A1
(43) Pub. Date: Apr. 30, 2026

(54) TRAINING A MACHINE LEARNING MODEL

(71) Applicant: Nokia Technologies Oy, Espoo (FI)

(72) Inventors: Francesco PASE, Cambridge (GB); Dimitrios SPATHIS, Cambridge (GB); Mohammad MALEKZADEH, Cambridge (GB); Soumyajit CHATTERJEE, Cambridge (GB)

(21) Appl. No.: 18/986,580

(22) Filed: Dec. 18, 2024

(30) Foreign Application Priority Data
Dec. 20, 2023 (FI) 20236400

(51) Int. Cl. G06N 20/00; G06F 9/455

(52) U.S. Cl. CPC G06N 20/00; G06F 9/45504

(57) ABSTRACT

A (server) apparatus comprising means for: creating a reduced machine learning model comprising: at least a compressed emulator configured to emulate a part of a machine learning model; and an adapter configured to reproduce a trainable part of the machine learning model, wherein the adapter is configured to provide inputs to the compressed emulator; sending to a client the compressed emulator and the adapter; and receiving, from the client, model update parameters that define the adapter after training, at the client, of the reduced machine learning model.

A (client) apparatus comprising means for: receiving, from a server, at least a compressed emulator configured to emulate a second fixed part of the machine learning model and an adapter configured to reproduce a trainable part of the machine learning model; creating a local reduced machine learning model by using the adapter to provide inputs to the second compressed emulator; performing training of the local reduced machine learning model using local training data to obtain model update parameters that define the adapter after training of the local machine learning model; and providing the model update parameters to the server.

### TECHNOLOGICAL FIELD

Examples of the disclosure relate to training a machine learning model.

### BACKGROUND

Machine learning is a field of computer science that gives computers the ability to learn without being explicitly programmed. The computer learns from experience E with respect to some class of tasks T and performance measure P if its performance at tasks in T, as measured by P, improves with experience E.

The computer can often learn from prior training data to make inferences based on future data.

Machine learning includes wholly or partially supervised learning and wholly or partially unsupervised learning. It may enable discrete outputs (for example classification, clustering) and continuous outputs (for example regression).

Machine learning may for example be implemented using different approaches such as cost function minimization, artificial neural networks, support vector machines and Bayesian networks for example. Cost function minimization may, for example, be used in linear and polynomial regression and K-means clustering. Artificial neural networks, for example with one or more hidden layers, model complex relationship between input vectors and output vectors. Support vector machines may be used for supervised learning. A Bayesian network is a directed acyclic graph that represents the conditional independence of a number of random variables.

### BRIEF SUMMARY

According to various, but not necessarily all, examples there is provided an apparatus comprising means for:
creating a reduced machine learning model comprising:
   a second compressed emulator configured to emulate a second fixed part of the machine learning model 10;
   an adapter configured to reproduce a third trainable part of the machine learning model,
      wherein the adapter is configured to provide inputs to the second compressed emulator;
sending to the client the second compressed emulator;
sending to the client the adapter; and
receiving, from the client, model update parameters that define the adapter after training, at the client, of the reduced machine learning model.

In some but not necessarily all examples, the created reduced machine learning model additionally comprises a first compressed emulator configured to emulate a first fixed part of a machine learning model, wherein the first compressed emulator is configured to provide inputs to the adapter; and wherein the apparatus further comprises means for sending to the client the first compressed emulator.

In some but not necessarily all examples, training the machine learning model by sending varying versions of the reduced machine learning model to train the machine learning model, wherein each varying version of the reduced machine learning model is defined by at least a compressed emulator and an adapter, wherein the adapter of each version is a different part of the machine learning model.

In some but not necessarily all examples, the apparatus further comprises means for:
training the machine learning model by sending varying versions of: the first compressed emulator, the second compressed emulator and the adapter.

In some but not necessarily all examples, the means for training the machine learning model are further configured to:
vary the first part emulated by the first compressed emulator, the second part emulated by the second compressed emulator (E2) and the third part reproduced by the adapter.

In some but not necessarily all examples, the means for training the machine learning model further comprise means for:
creating an updated reduced machine learning model comprising:
   an updated first compressed emulator configured to emulate an updated first part of the machine learning model;
   an updated second compressed emulator configured to emulate an updated second part of the machine learning model;
   an updated adapter configured to reproduce an updated third part of the machine learning model;
      wherein the updated first compressed emulator is configured to provide inputs to the updated adapter and the updated adapter is configured to provide inputs to the updated second compressed emulator;
   sending to the client at least the updated adapter;
   receiving, from the client, additional model update parameters that define the updated adapter after training, at the client, of the updated reduced machine learning model; and
   updating the machine learning model based on the additional model update parameters.

In some but not necessarily all examples, the apparatus further comprises means for:
sending to the client the updated first compressed emulator;
sending to the client the updated second compressed emulator.

In some but not necessarily all examples, the third trainable part of the machine learning model is different to the updated third part of the machine learning model.

In some but not necessarily all examples, the updated first part of the machine learning model comprises the first fixed part of the machine learning model and the third trainable part of the machine learning model.

In some but not necessarily all examples, the updated third part of the machine learning model comprises at least part of the second fixed part of the machine learning model.

In some but not necessarily all examples, the apparatus further comprises means for: updating the machine learning model based on at least the model update parameters.

In some but not necessarily all examples, the means for creating the reduced machine learning model are configured to:
generate the second compressed emulator by performing knowledge distillation on the second part of the machine learning model.

In some but not necessarily all examples, the apparatus further comprises means for:
sending to a second client the first compressed emulator;
sending to the second client the second compressed emulator;
sending to the second client the adapter;
receiving, from the second client, model update parameters that define the adapter after training, at the second client, of the reduced machine learning model; and
performing an update to the machine learning model using the model update parameters that define the adapter after training at the client, and using the model update parameters that define the adapter after training at the second client.

In some but not necessarily all examples, the apparatus further comprises means for:
creating a second reduced machine learning model for a first client, comprising:
   a third compressed emulator configured to emulate a fourth part of the machine learning model;
   a fourth compressed emulator configured to emulate a fifth part of the machine learning model;
   a second adapter configured to reproduce a sixth part of the machine learning model; wherein at least one of: the first, second or third parts of the machine learning model is different to the fourth, fifth, or sixth parts respectively of the machine learning model; and wherein:
      the third compressed emulator is configured to provide inputs to the second adapter and the second adapter is configured to provide inputs to the fourth compressed emulator; and
sending to the first client the third compressed emulator, the fourth compressed emulator and the second adapter.

In some but not necessarily all examples, the reduced machine learning model defined by the first compressed emulator, the second compressed emulator and the adapter is dependent upon a processing capability of the client.

In some but not necessarily all examples, the apparatus further comprises means for:
receiving information indicating the processing capability of the client.

In some but not necessarily all examples, the machine learning model is a foundation model.

In some but not necessarily all examples, the machine learning model is an artificial neural network and the adapter comprises one or more adjacent layers of the artificial neural network.

According to various, but not necessarily all, examples there is provided a method comprising:
creating a reduced machine learning model 30 comprising:
creating a reduced machine learning model comprising:
   a second compressed emulator configured to emulate a second fixed part of the machine learning model;
   an adapter configured to reproduce a third trainable part of the machine learning model,
      wherein the adapter is configured to provide inputs to the second compressed emulator;
sending to the client the second compressed emulator;
sending to the client the adapter; and
receiving, from the client, model update parameters that define the adapter after training, at the client, of the reduced machine learning model.

According to various, but not necessarily all, examples there is provided a computer program comprising instructions that when executed by one or more processors of an apparatus causes:
creating a reduced machine learning model comprising:
   a second compressed emulator configured to emulate a second fixed part of the machine learning model;
   an adapter configured to reproduce a third trainable part of the machine learning model,
      wherein the adapter is configured to provide inputs to the second compressed emulator;
sending to the client the second compressed emulator;
sending to the client the adapter; and
receiving, from the client, model update parameters that define the adapter after training, at the client, of the reduced machine learning model.

According to various, but not necessarily all, examples there is provided an apparatus comprising means for:
receiving, from the server, a second compressed emulator configured to emulate a second fixed part of a machine learning model;
receiving, from the server, an adapter configured to reproduce a third trainable part of the machine learning model, wherein the third trainable part is intermediate a first part and the second part of the machine learning model;
creating a local reduced machine learning model by using the adapter to provide inputs to the second compressed emulator;
performing training of the local reduced machine learning model using local training data to obtain model update parameters that define the adapter after training of the local machine learning model; and
providing the model update parameters to the server.

In some but not necessarily all examples, the apparatus comprises means for receiving, from a server, a first compressed emulator configured to emulate a first fixed part of a machine learning model; wherein the means for creating the local reduced machine learning model uses the first compressed emulator to provide inputs to the adapter.

In some but not necessarily all examples, the apparatus further comprises means for:
training machine learning model comprising receiving varying versions of: the first compressed emulator, the second compressed emulator and the adapter to be trained by the apparatus.

In some but not necessarily all examples, the means for training the machine learning model further comprises means for:
receiving, from the server, an updated first compressed emulator configured to emulate an updated first part of the machine learning model;
receiving, from the server, an updated second compressed emulator configured to emulate an updated second part of the machine learning model;
receiving, from the server, an updated adapter configured to reproduce an updated third part of the machine learning model;
creating an updated local reduced machine learning model by using the updated first compressed emulator to provide inputs to the updated adapter and using the updated adapter to provide inputs to the updated second compressed emulator;
performing training of the updated local reduced machine learning model using local training data to obtain additional model update parameters that define the updated adapter after training of the updated local machine learning model; and
providing the additional model update parameters to the server.

In some but not necessarily all examples, the third trainable part of the machine learning model is different to the updated third part of the machine learning model.

In some but not necessarily all examples, the updated first part of the machine learning model comprises the first fixed part of the machine learning model and the third trainable part of the machine learning model.

In some but not necessarily all examples, the updated third part of the machine learning model comprises at least part of the second fixed part of the machine learning model.

In some but not necessarily all examples, the apparatus is configured to use same local training data for a plurality of training epochs in a training round, before providing the model update parameters to the server once per training round.

In some but not necessarily all examples, the apparatus is configured to determine the output of the first compressed emulator based on the local training data for a first epoch of the training round and to re-use the output of the first compressed emulator, without redetermination, in subsequent epochs of the training round.

In some but not necessarily all examples, the apparatus is configured to vary the number of epochs per training round.

In some but not necessarily all examples, the apparatus is configured to prevent transfer of the local training data to the server.

In some but not necessarily all examples, the machine learning model is a foundation model.

In some but not necessarily all examples, the machine learning model is an artificial neural network and the adapter comprises one or more adjacent layers of the artificial neural network.

In some but not necessarily all examples, the apparatus comprises means for:
providing a processing capability of the apparatus to the server.

In some but not necessarily all examples, the apparatus is configured as a hand-held device or personal portable electronic device.

In some but not necessarily all examples, the apparatus comprises means for:
storing, for a first training data epoch, data input to a first adapter of a first reduced machine learning model defined by at least a compressed emulator and the first adapter; and using, for a later second training data epoch, the stored data as input to a second adapter of a second reduced machine learning model defined by at least a compressed emulator and the second adapter. In an example, the first adapter is the same as the second adapter, the first reduced machine learning model is the same as second reduced machine learning model, and the first training data epoch & second training data epoch are in same round. In another example, the first adapter is not the same as the second adapter, the second adapter follows first adapter in the ML model, the first reduced machine learning model is not the same as the second reduced machine learning model, the first training data epoch & second training data epoch are in DIFFERENT rounds.

According to various, but not necessarily all, examples there is provided a method comprising:
receiving, from the server, a second compressed emulator configured to emulate a second fixed part of the machine learning model;
receiving, from the server, an adapter configured to reproduce a third trainable part of the machine learning model, wherein the third trainable part is intermediate the first part and the second part;
creating a local reduced machine learning model by using the adapter to provide inputs to the second compressed emulator;
performing training of the local reduced machine learning model using local training data to obtain model update parameters that define the adapter after training of the local machine learning model; and
providing the model update parameters to the server.

According to various, but not necessarily all, examples there is provided a computer program comprising instructions that when executed by one or more processors of an apparatus causes:
receiving, from the server, a second compressed emulator configured to emulate a second fixed part of the machine learning model;
receiving, from the server, an adapter configured to reproduce a third trainable part of the machine learning model, wherein the third trainable part is intermediate the first part and the second part;
creating a local reduced machine learning model by using the adapter to provide inputs to the second compressed emulator;
performing training of the local reduced machine learning model using local training data to obtain model update parameters that define the adapter after training of the local machine learning model; and
providing the model update parameters to the server.

According to various, but not necessarily all, examples there is provided a system comprising the apparatus for sending the adapter configured as a server and one or more apparatus for receiving the adapter configured as one or more respective clients.

According to various, but not necessarily all, examples there is provided an apparatus comprising means for: receiving, from a server, a second compressed emulator configured to emulate a second fixed part of a machine learning model; receiving, from the server, an adapter configured to reproduce a third trainable part of the machine learning model, wherein the third trainable part is intermediate a first fixed part and the second fixed part of the machine learning model; creating a local reduced machine learning model by using the adapter to provide inputs to the second compressed emulator; performing training of the local reduced machine learning model using local training data to obtain model update parameters that define the adapter after training of the local machine learning model; and providing the model update parameters to the server.

In some but not necessarily all examples, the apparatus further comprising means for: obtaining an output of a previous adapter for the local training data, wherein the previous adapter was received by the apparatus in a preceding training round; and wherein performing training of the local reduced machine learning model using local training data to obtain model update parameters comprises training the local reduced machine learning model using the output of the previous adapter as an input to the adapter.

In some but not necessarily all examples, training the local reduced machine learning model using the output of the previous adapter as an input to the adapter further comprises storing an output of the adapter.

In some but not necessarily all examples, the apparatus further comprises: only receiving a second compressed emulator and an adapter. The apparatus further comprising not receiving a compressed part representing the first fixed part.

In some but not necessarily all examples, the apparatus further comprises: receiving, from the server, a first partial compressed emulator configured to emulate a part of the first fixed part of the machine learning model, wherein the part of the first fixed part was reproduced by a previous adapter in a previous training round; wherein: creating the local reduced machine learning model by using the adapter to provide inputs to the second compressed emulator, further comprises using the first partial compressed emulator to provide inputs to the adapter; and wherein: performing training of the local reduced machine learning model using local training data further comprises: obtaining saved data provided as input to the previous adapter in the previous training round; inputting saved data to the first partial compressed emulator; and saving an output of the first partial compressed emulator for use in a subsequent training round.

According to various, but not necessarily all, examples there is provided a (server) apparatus comprising means for: creating a reduced machine learning model comprising: at least a compressed emulator configured to emulate a part of a machine learning model; and an adapter configured to reproduce a trainable part of the machine learning model, wherein the adapter is configured to provide inputs to the compressed emulator; sending to a client the compressed emulator and the adapter; and receiving, from the client, model update parameters that define the adapter after training, at the client, of the reduced machine learning model.

According to various, but not necessarily all, examples there is provided a (client) apparatus comprising means for: receiving, from a server, at least a compressed emulator configured to emulate a second fixed part of the machine learning model and an adapter configured to reproduce a trainable part of the machine learning model; creating a local reduced machine learning model by using the adapter to provide inputs to the second compressed emulator; performing training of the local reduced machine learning model using local training data to obtain model update parameters that define the adapter after training of the local machine learning model; and providing the model update parameters to the server.

According to various, but not necessarily all, examples there is provided an apparatus comprising means for:
creating a reduced machine learning model comprising:
   a first compressed emulator configured to emulate a first fixed part of a machine learning model;
   a second compressed emulator configured to emulate a second fixed part of the machine learning model 10;
   an adapter configured to reproduce a third trainable part of the machine learning model,
      wherein the first compressed emulator is configured to provide inputs to the adapter and the adapter is configured to provide inputs to the second compressed emulator;
sending to a client the first compressed emulator;
sending to the client the second compressed emulator;
sending to the client the adapter; and
receiving, from the client, model update parameters that define the adapter after training, at the client, of the reduced machine learning model.

According to various, but not necessarily all, examples there is provided an apparatus comprising means for:
receiving, from a server, a first compressed emulator configured to emulate a first fixed part of a machine learning model;
receiving, from the server, a second compressed emulator configured to emulate a second fixed part of the machine learning model;
receiving, from the server, an adapter configured to reproduce a third trainable part of the machine learning model, wherein the third trainable part is intermediate the first part and the second part;
creating a local reduced machine learning model by using the first compressed emulator to provide inputs to the adapter and using the adapter to provide inputs to the second compressed emulator;
performing training of the local reduced machine learning model using local training data to obtain model update parameters that define the adapter after training of the local machine learning model; and
providing the model update parameters to the server.

According to various, but not necessarily all, examples there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

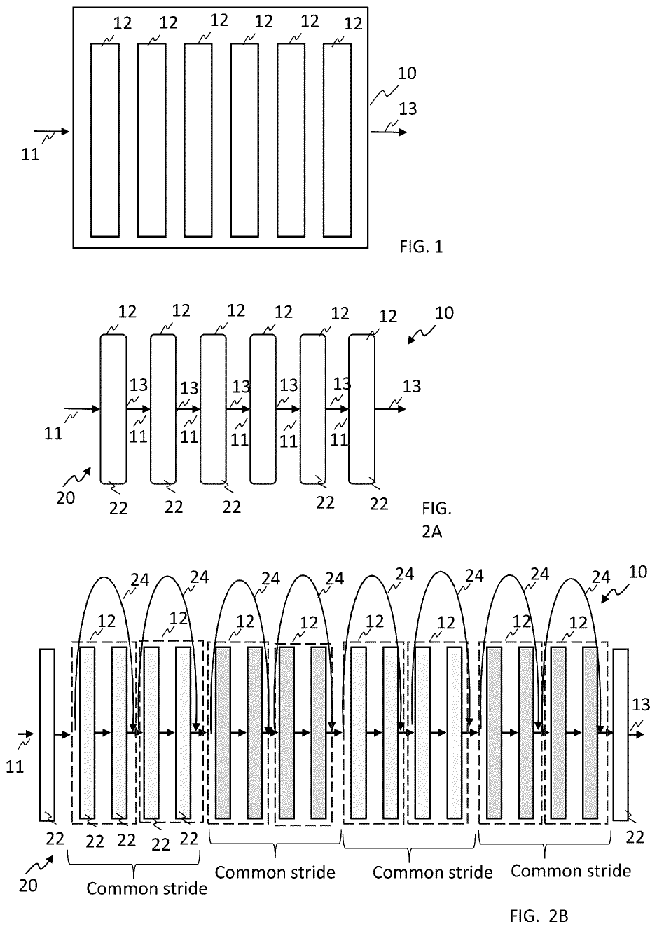

FIG. 1 shows an example of a machine learning model 10 comprising parts 12;

FIG. 2A shows an example of a machine learning model 10 comprising parts 12, configured as an artificial neural network 20 comprising multiple layers 22;

FIG. 2B shows an example of a machine learning model 10 comprising parts 12, configured as an artificial neural network 20, comprising multiple layers 22, that has a residual network configuration and comprises residual blocks;

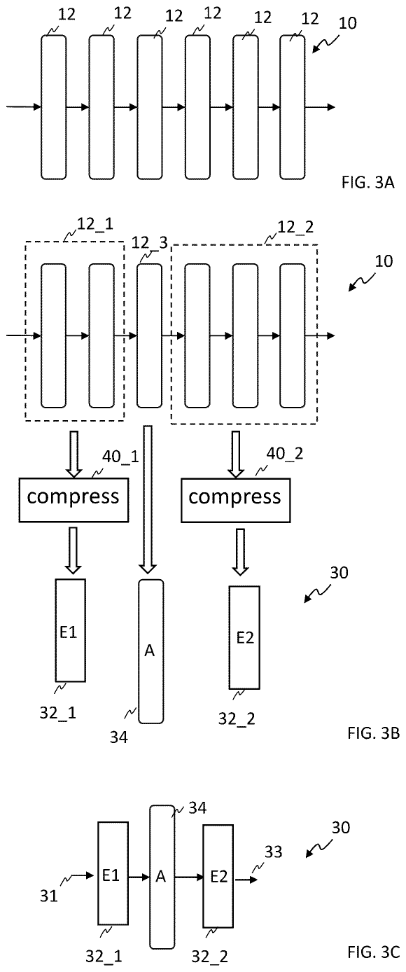

FIGS. 3A to 3C illustrate partitioning a machine learning model 10 to parts 12_1, 12_2, 12_3 and forming a reduced machine learning model 30 comprising an adapter 34 and at least one compressed emulator 32_1, 32_2;

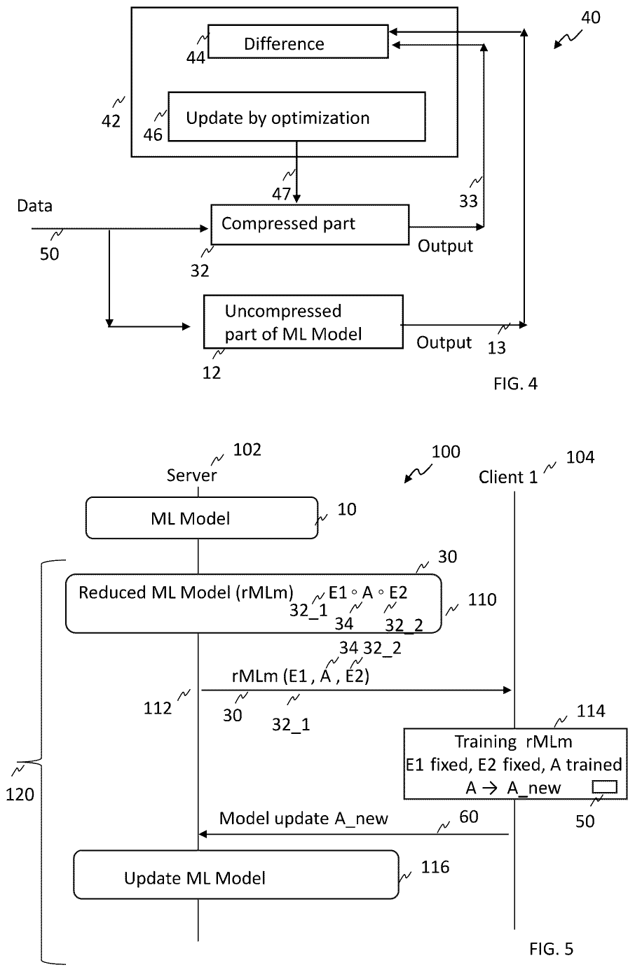

FIG. 4 illustrates an example of forming a compressed emulator;

FIG. 5 illustrates a system 100 comprising a server apparatus 102 and at least one client apparatus 104 where the reduced machine learning model 30 (rMLm) is transferred from the server apparatus 102 to the client apparatus 104 for training at the client apparatus 104, where the emulator(s) 32_1, 32_2 are fixed/frozen and the adapter 34 is updated;

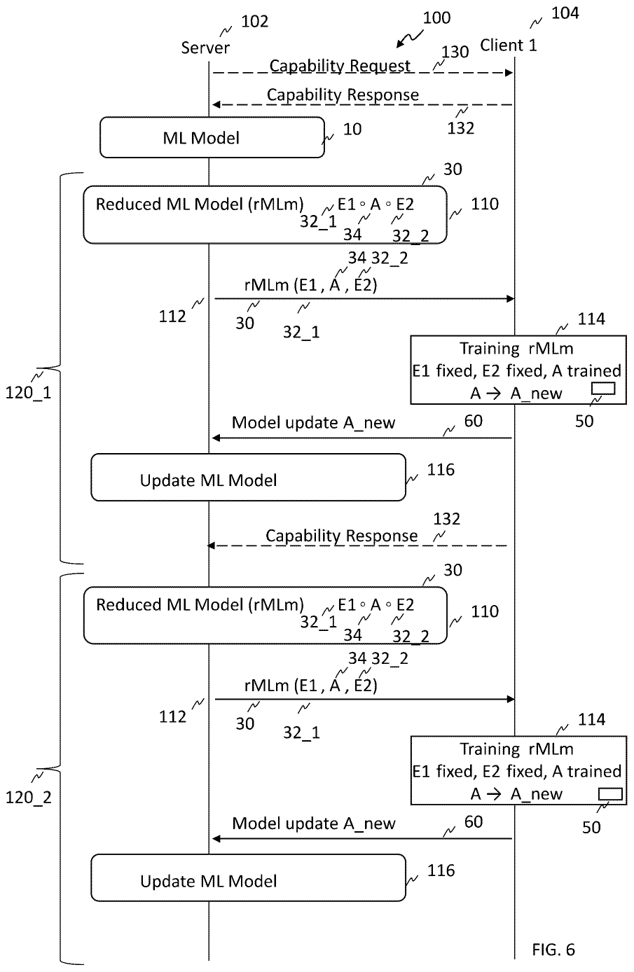

FIG. 6 illustrates the system 100 operating over multiple rounds 120_1, 120_2, and the optional dependence of the reduced machine learning model (rMLM) on a capability of the client apparatus 104;

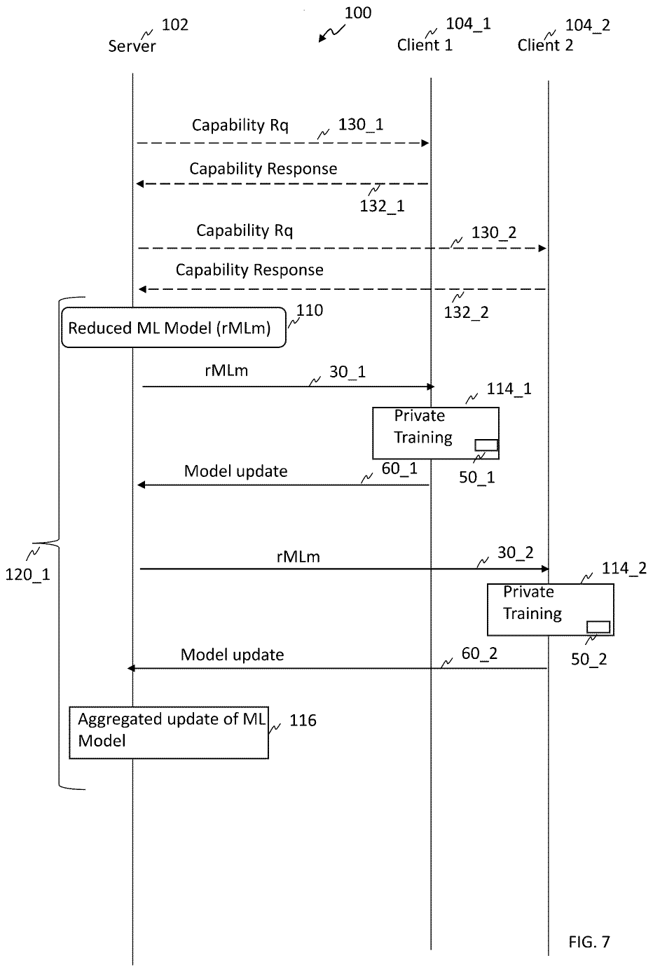

FIG. 7 illustrates the system 100 comprising a server apparatus 102 and multiple clients 104 where the reduced machine learning model 30 is transferred from the server to the clients for training 114_1, 114_2 at the respective clients 104_1, 104_2 using training data 50_1, 50_2 that is private to the respective clients 104_1, 104_2;

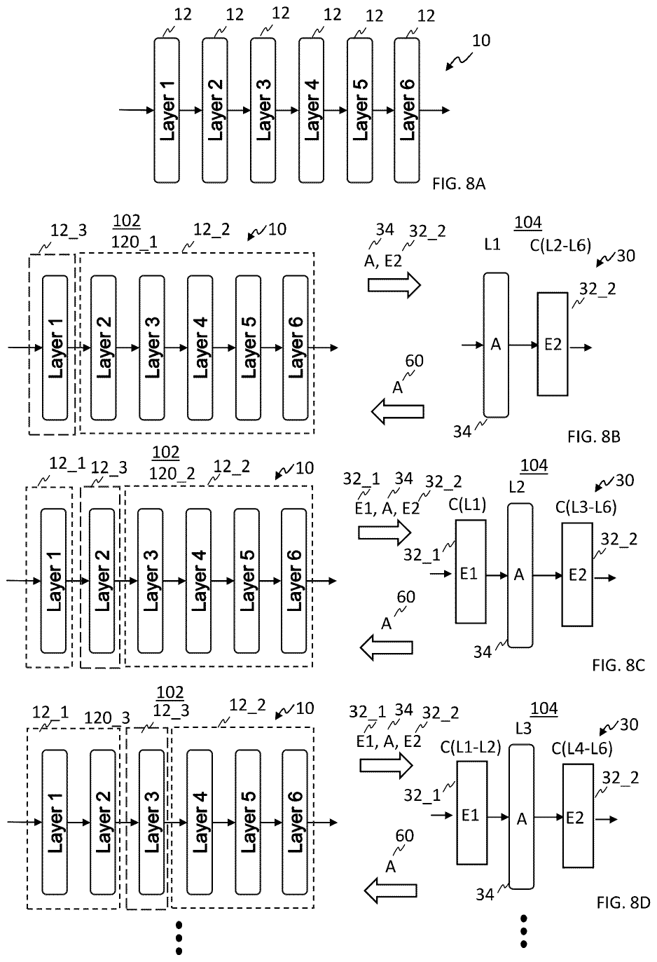

FIGS. 8A to 8D illustrate the process of training the machine learning model 10 by updating multiple different adapters 34 via client-training of multiple different reduced machine learning models;

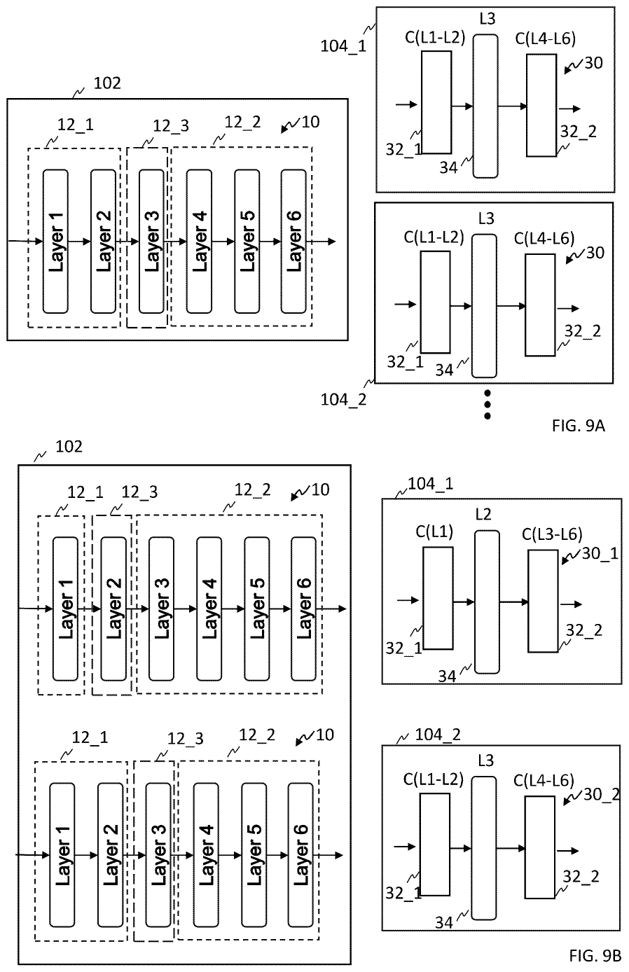

FIGS. 9A & 9B extend the example of FIGS. 8A to 8D to multiple clients 104_1, 104_2 with a common reduced machine learning model for the clients 104_1, 104_2 (FIG. 9A) and different reduced machine learning models for the clients 104_1, 104_2 (FIG. 9B);

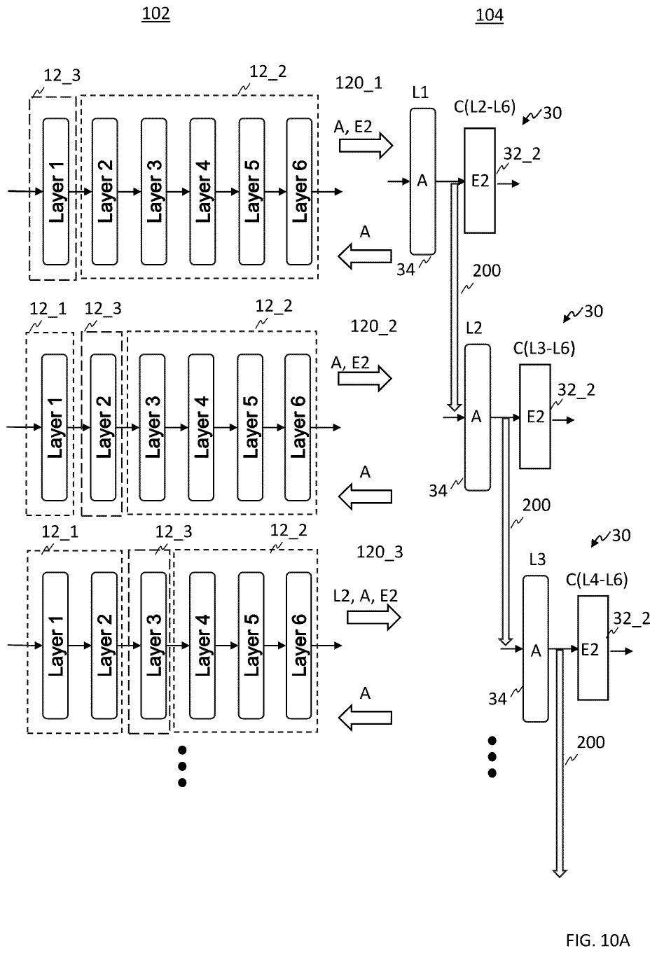

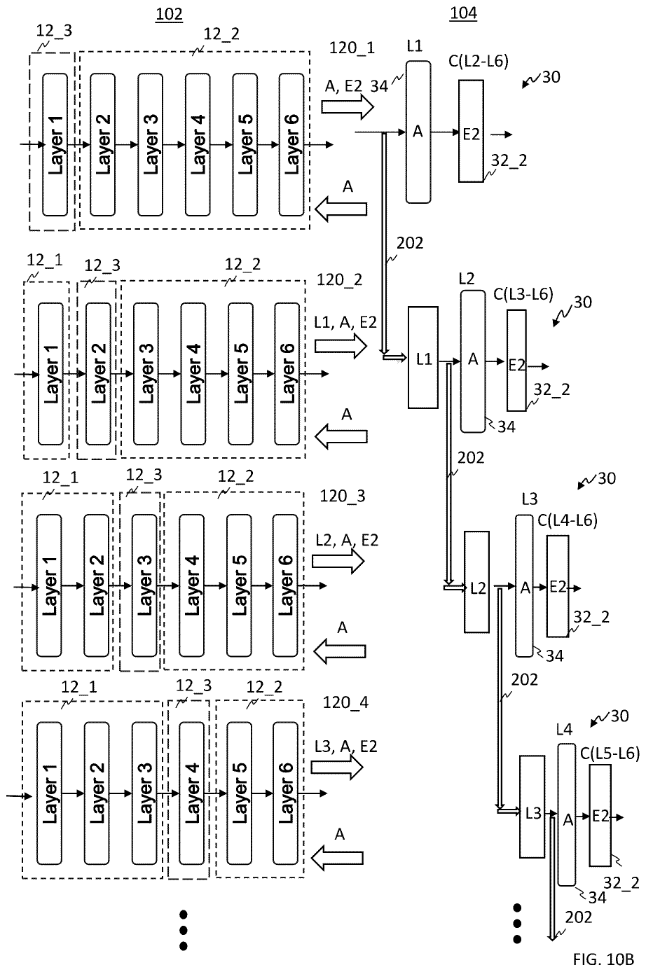

FIG. 10A illustrates an example;

FIG. 10B illustrates an example;

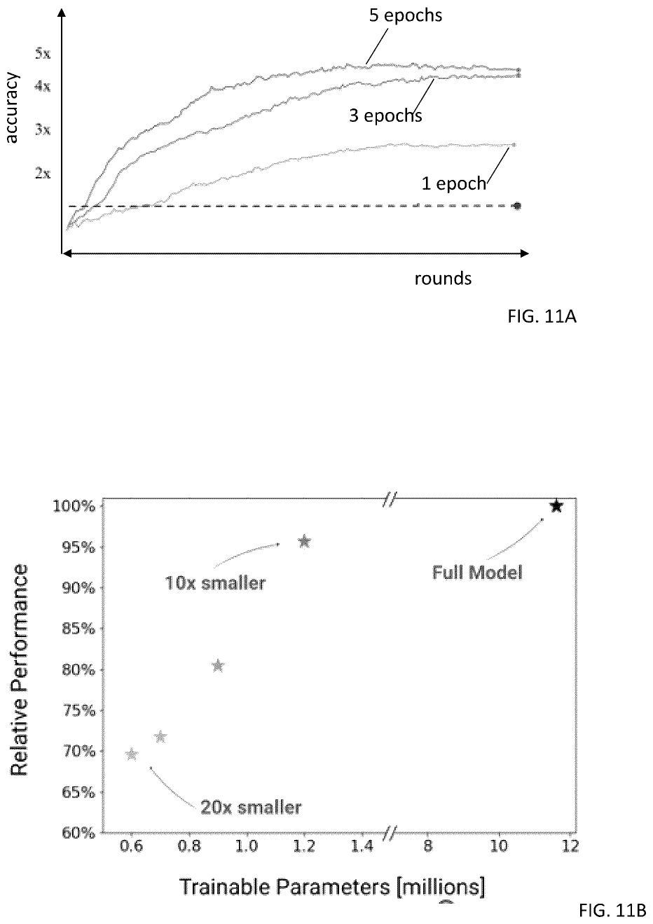

FIG. 11A illustrates an example of how performance can vary with number of rounds and with number of steps (epochs);

FIG. 11B illustrates an example of how performance can vary with compression;

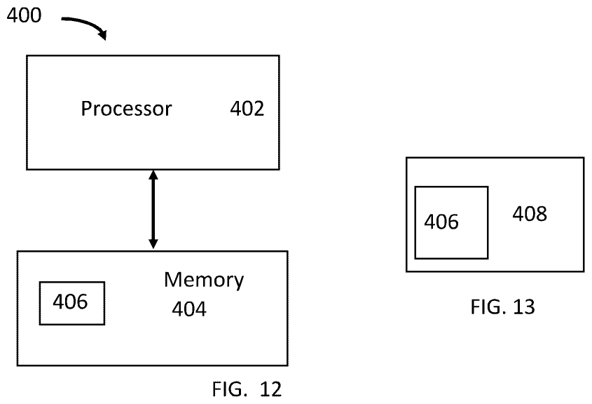

FIG. 12 illustrates an example of a controller for controlling one or more of the described functions of the client apparatus 104 or the server apparatus 102;

FIG. 13 illustrates an example of a computer program 406 that can be executed, in at least some examples, by the controller 400 to control one or more of the described functions of the client apparatus 104 or the server apparatus 102.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the following description a class (or set) can be referenced using a reference number without a subscript index (e.g. 12) and a specific instance of the class (member of the set) can be referenced using the reference number with a numerical type subscript index (e.g. 12_1) and a non-specific instance of the class (member of the set) can be referenced using the reference number with a variable type subscript index (e.g. 12_i).

### DETAILED DESCRIPTION

FIG. 1 illustrates an example of a machine learning (ML) model 10. The machine learning model 10 comprises parts 12. That is the machine learning model 10 has an architecture comprised, logically or otherwise, of parts 12 or the machine learning model can be partitioned, logically or otherwise, into parts 12. A part is any logical sub-unit of the machine learning model 10. Parts 12 are not necessarily the same or of the same size and can represent an arbitrary logical sub-unit of the machine learning model 10.

Reference is made to specific parts such as the first part 12_1 (also referred to as the first emulator part 12_1), the second part 12_2 (also referred to as the second emulator part 12_2), the third part 12_3 (also referred to as the adapter part 12_3).

The term “block” or “module” can be used to refer to the smallest trainable unit (smallest trainable part 12) of the machine learning model 10. The third part 12_3 (also referred to as the adapter part 12_3) can comprise one or more blocks or modules. The third part 12_3 (also referred to as the adapter part 12_3) can therefore comprise a smallest trainable unit (smallest trainable part) of the machine learning model 10 or multiple (two or more) smallest trainable units (smallest trainable parts) of the machine learning model 10.

In an artificial neural network a “part” can, for example, comprise one or more layers, for example adjacent layers. In an artificial neural network a “block” or “module” comprises one or more adjacent layers. In an artificial neural network, the third part 12_3 (also referred to as the adapter part 12_3) can therefore comprise one or more adjacent layers.

The machine learning (ML) model 10 is configured, after training, to receive an input 11 and produce an output 13.

The machine learning model 10 may for example be implemented using different approaches such as cost function minimization, artificial neural networks, support vector machines and Bayesian networks for example. Cost function minimization may, for example, be used in linear and polynomial regression and K-means clustering. Artificial neural networks, for example with one or more hidden layers, model complex relationship between input vectors and output vectors. Support vector machines may be used for supervised learning. A Bayesian network is a directed acyclic graph that represents the conditional independence of a number of random variables.

The machine learning model 10 is defined by a set of model parameters that specify operation of the machine learning model 10. When the machine learning model 10 is trained, the model parameters that specify operation of the machine learning model 10 are updated.

In some examples, the model parameters comprise weights. In some examples, the model parameters comprise weights and biases.

In some examples, the model parameters comprise a differential of a loss/cost function with respect to a weight for gradient descent.

In an artificial neural network a weight is defined between two artificial neurons and defines the strength of connection (gain) between the neurons. The weight wᵢⱼ determines the influence of a signal sⱼ (output from the artificial neuron labelled j and input to the artificial neuron labelled i) on the output sᵢ from the artificial neuron labelled i. This is because the output sᵢ is the weighted summation of the input signals sᵢ, offset by the bias U i.e.

$${s}_{i} = b + {\sum }_{j}^{} {w}_{ij} {s}_{j}$$

In at least some examples, the machine learning model 10 is a foundation model. A foundation model is a machine learning model that is trained on broad data and the model can be adapted (e.g., fine-tuned) to a wide range of downstream tasks by updating the model parameters. A foundation model can be considered a paradigm for building application specific machine learning models where the foundation model, trained on a large amount of unlabeled data, can be adapted to many applications

During a training phase of a machine learning model, training data 50 is provided as an input 11 to the machine learning model 10 which produces an output 13. The loss/cost function quantifies how the output 13 varies from an expected output.

The model parameters are updated to decrease the loss/cost function (reduce and in some examples minimize the error). This is described as ‘minimization’ or ‘optimization’ or ‘model parameter updating’ as it is a process designed to achieve a lower loss/cost (or more optimal loss/cost), although it does not imply that the minimum or optimum loss/cost (local or global) is achieved.

One approach to model parameter updating is to use gradient descent. The gradient represented by the rate of change of the loss/cost function with respect to the model parameters is descended to find different model parameters. Gradient descent finds a set of the model parameters that perform well against some performance measure (the loss/cost function). The algorithm is iterative and occurs over multiple discrete iterations. Each iteration involves using the machine learning model with the current set of model parameters to make predictions on some samples of training data, comparing the predictions to the real expected outcomes to calculate an error, and using the error to update the model parameters.

Training data comprises many samples. A batch is the set of samples used to compute the gradient to perform one iteration of gradient descent. A batch size is the number of samples in the set. An epoch is a full pass through training data. A machine learning model can be trained (updated) repetitively (for example, cyclically) over many epochs. In the case of artificial neural networks, the backpropagation update algorithm is used for training.

In the examples, the machine learning model 10 is trained 114 locally at one or more client apparatus 104 using local training data 50. One or more parts 12 of server-based machine learning model 10 are updated each training round 120. After multiple training rounds 120, the whole server-based machine learning model 10 has been updated and the training cycle has been completed. The training cycle can then be repeated with the same or different training data 50.

FIG. 2A illustrates an example of an artificial neural network (ANN) 20. An artificial neural network 20 is a machine learning model 10 comprising a number of highly interconnected processing elements (artificial neurons) that process information by their dynamic state response to inputs including inputs dependent upon the dynamic state response of interconnected artificial neurons. An artificial neural network 20 is arranged as a directed graph whose nodes are artificial neurons and whose vertices are connections between artificial neurons.

Each artificial neuron can be configured to determine an output based on a weighted sum of its inputs. In an artificial neural network a weight is defined between two artificial neurons and defines the strength of connection (gain) between the neurons. The weight wᵢⱼ determines the influence of a signal sⱼ (output from the artificial neuron labelled j and input to the artificial neuron labelled i) on the output sᵢ from the artificial neuron labelled i. This is because the output sᵢ is dependent on the weighted summation of the input signals sᵢ, offset by the bias b, for example:

$$b + {\sum }_{j}^{} {w}_{ij} {s}_{j}$$

The example illustrated is a several layered ANN comprising multiple layers 22. An input layer is the first (leftmost) layer 22 and receives at least some of its inputs 11 from outside the ANN 20 and an output layer is the final (rightmost) layer 22 and provides at least some of its outputs 13 outside the ANN 20. The layers 22 between the first and final layer are hidden layers. For artificial neurons in the hidden layer(s) and the final layer, the inputs comprise outputs from the artificial neurons in the preceding layer. Thus each of the artificial neurons determines whether or not a weighted sum of its inputs causes an activation function to produce an output.

In a feedforward stage, the training data is propagated through the ANN 20 from input 11 to output 13 by computing, in order, the hidden layers' outputs (which are the inputs to the next layer). Then the ANN weights wᵢⱼ are adjusted to reduce an error with respect to the weights wᵢⱼ. The error is produced by a loss/cost function and captures a difference between the output and an expected output. For each weight, the slope or derivative of the error is found.

The weight adjusted in dependence upon a negative of this derivative, so as to go down slope towards minimum-error. Backpropagation computes the gradient of a loss/cost function with respect to the weights of the ANN 20 layer-by-layer.

Each part 12 of the machine learning model comprises one or more adjacent layers 22 of the ANN 20. In this example, each part 12 of the machine learning model 10 comprises only one layer 22 of the ANN. However, FIG. 2B illustrates an example where each part 12 of the machine learning model 10 is a block. In this example, each part/block comprises multiple (for example, two or more) adjacent layers 22 of the ANN 20. FIG. 2B illustrates an ANN 20 configured as a residual network and each part/block 12 of the machine learning model 10 comprises a residual block of the residual network. A residual neural network (ResNet) is a deep ANN 20 with skip connections 24 (residual connections). LSTM networks and Transformer models also use skip connections. A residual network is constructed by stacking a series of sub-networks (residual blocks). A skip connection (residual connection) 24 connects an input of a residual block with its output. The input to the next residual block is obtained by adding the input (via the skip connection 24) to the output of the residual block. FIG. 2B illustrates a schematic of ResNet 18 which is a convolutional ANN that comprises 18 layers 22, and has residual blocks of size two layers.

FIG. 3A illustrates an example of a machine learning model 10 comprising parts 12.

FIG. 3B illustrates an example of creating a reduced machine learning model 30 that emulates the machine learning model 10. The machine learning model 10 is partitioned into parts 12_i. In this example, it is partitioned into a first part 12_1, a second part 12_2 and a third part 12_3. The third part 12_3 is intermediate the first part 12_1 (the input part) and the second part 12_2 (the output part).

In this example, the machine learning model 10 is an ANN 20 and the first part 12_1 and the second part 12_2 each comprises multiple layers 22 of the ANN 20, and the third part 12_3 comprises one layer 22 of the ANN 20.

The first part 12_1 of the machine learning model 10 is compressed 40_1 to form a first compressed emulator (E1) 32_1 which is configured to emulate the first part 12_1 of a machine learning model 10.

The second part 12_2 of the machine learning model 10 is compressed 40_2 to form a second compressed emulator (E2) 32_2 which is configured to emulate the second part 12_2 of the machine learning model 10.

The third part 12_3 of the machine learning model 10 is used to provide an adapter (A) 34. In some but not necessarily all examples, the third part 12_3 of the machine learning model is provided without modification as the adapter (A) 34. The adapter 34 is configured to reproduce the third part 12_3 of the machine learning model 10.

As illustrated in FIG. 3C, the reduced machine learning model 30, in use, comprises the first compressed emulator (E1) 32_1 providing inputs to the adapter 34 which provides inputs to the second compressed emulator (E2) 32_2. An input 31 to the first compressed emulator (E1) 32_1 produces an output 33 from the second compressed emulator (E2) 32_2.

The first compressed emulator (E1) 32_1 is fixed (frozen, not trained) and is configured to emulate a first part 12_1 of a machine learning model 10. The first part 12_1 of the machine learning model is a fixed (frozen, not trained) part of the machine learning model 10.

The second compressed emulator (E2) 32_2 is fixed (frozen, not trained) and is configured to emulate a second part 12_2 of the machine learning model 10. The second part 12_2 of the machine learning model 10 is a fixed (frozen, not trained) part of the machine learning model 10.

A part 12 of the machine learning model that is a fixed (frozen, not trained) part of the machine learning model 10 is referred to as a fixed part 12 of the machine learning model 10. A first part 12_1 of the machine learning model that is a fixed (frozen, not trained) part of the machine learning model 10 is referred to as a first fixed part 12_1 of the machine learning model 10. A second part 12_2 of the machine learning model 10 that is a fixed (frozen, not trained) part of the machine learning model 10 is referred to as a second fixed part 12_2 of the machine learning model 10.

The adapter 34 is trainable (not fixed/frozen) and is configured to reproduce a third trainable (not fixed/frozen) part 12_3 of the machine learning model 10.

The emulators 32 are compressed models. The first compressed emulator (E1) 32_1 is defined by less information than is used to define the first part 12_1 of the machine learning model 10. The second compressed emulator (E2) 32_2 is defined by less information than is used to define the second part 12_2 of the machine learning model 10. The reduction in information can arise from using less model parameters. In some examples, the first compressed emulator (E1) 32_1 is defined by less model parameters than are used to define the first part 12_1 of the machine learning model 10 and/or the second compressed emulator (E2) 32_2 is defined by less model parameters than are used to define the second part 12_2 of the machine learning model 10. The reduction in information can arise from using less precise (quantized) model parameters. In some examples, the first compressed emulator (E1) 32_1 is defined by model parameters that have less precision than those used to define the first part 12_1 of the machine learning model 10 and/or the second compressed emulator (E2) 32_2 is defined by model parameters that have less precision than those used to define the second part 12_2 of the machine learning model 10.

When the reduced machine learning model 30 is trained, the model parameters of the first compressed emulator (E1) 32_1 are static and the model parameters of the second compressed emulator (E2) 32_2 are static and the model parameters of the adapter 34 are updated during training.

The first compressed emulator (E1) 32_1 is a compressed version of the first fixed part 12_1 of the machine learning model 10 and represents it with less model parameters. The second compressed emulator (E2) 32_2 is a compressed version of the second fixed part 12_2 of the machine learning model 10 and represents it with less model parameters. The adapter (A) 34 is a non-compressed version of the third fixed part 12_3 of the machine learning model 10 and represents it with the same model parameters.

In at least some examples, the machine learning model 10 is an artificial neural network 20 and the adapter 34 comprises one or more adjacent layers 22 of the artificial neural network 20 (see FIGS. 2A, 2B).

In at least some examples, the machine learning model 10 is a residual neural network (Resnet) 20 and the adapter 34 comprises one or more residual blocks of the residual neural network (see FIG. 2B).

As the first compressed emulator (E1) 32_1 is fixed/frozen during training, back-propagation need only occur through the second compressed emulator (E2) 32_2 and the adapter 34, to successfully update the adapter 34. Back-propagation through the first compressed emulator (E1) 32_1 is not required.

The compression 40 of a part 12 of a machine learning model 10 can be performed in different ways including neural network pruning, quantization, or distillation which all compress a size of a part 12 of a machine learning model 10.

FIG. 4 illustrates an example of distillation (self-distillation). The objective for the first compressed emulator (E1) 32_1 is to provide, without significant overhead, accurate inputs to the adapter 34. The objective for the second compressed emulator (E2) 32_2 is to provide, without significant overhead, an accurate output for the machine learning model 10 and to provide appropriate gradient directions to update the adapter 34 during back-propagation gradient-descent.

The training data 50 is provided to the (uncompressed) first part 12_1 of the machine learning model 10 to obtain a (target) output 13. The training data 50 is provided to the (putative) compressed part (first emulator 32_1) of the reduced machine learning model 30 to obtain a (putative) output 33. An update module 42 determines at block 44 a difference between the target output 13 and the putative output 33. The difference can be calculated as a mean squared error (MSE) (or other general loss function, like cross entropy) over the training data. The update module at block 46 then determines, using model parameter updating, updates 47 to the (putative) compressed part (first emulator 32_1) of the reduced machine learning model 30. This can, for example be achieved by gradient descent and back-propagation.

The training data 50 is provided to the (uncompressed) second part 12_2 of the machine learning model 10 to obtain a (target) output 13. The training data 50 is provided to the (putative) compressed part (second emulator 32_1) of the reduced machine learning model 30 to obtain a (putative) output 33. An update module 42 determines at block 44 a difference between the target output 13 and the putative output 33. The difference can be calculated as a mean squared error (MSE) (or other general loss function, like cross entropy) over the training data. The update module at block 46 then determines, using model parameter updating, updates 47 to the (putative) compressed part (second emulator 32_2) of the reduced machine learning model 30. This can, for example be achieved by gradient descent and back-propagation.

FIG. 5 illustrates an example of a system 100 for cooperatively training a machine learning model 10, for example as previously described.

The system comprises a server apparatus 102 and at least one client apparatus 104.

The reduced machine learning model 30 is trained 114 at a client apparatus 104 (or separately at multiple (for example two or more) client apparatuses). This can be described as local training, at the client, of the (local) reduced machine learning model 30 using (local) training data 50. This can be described as remote training, from the server, of the (remote) reduced machine learning model 30 using (remote) training data 50. The training data 50 can be private to the client apparatus 104 (not shared with the server apparatus 102).

The client apparatus 104 performs training 114 of the reduced machine learning model 30 using training data 50 to obtain model update parameters 60 that define the adapter 34 after training 114 of the local reduced machine learning model 30.

The model update parameters 60 that define the adapter 34 after training 114 of the local reduced machine learning model 30 at the client apparatus 104, are transferred to the server apparatus 102, where the server apparatus 102 updates 116 the machine learning model 10.

This example illustrates an example of a system 100 comprising one client apparatus 104, however, later figures illustrate examples of the system comprising multiple client apparatuses 104.

In this example, the server apparatus 102 creates 110 and distributes 112 the reduced machine learning model 30. However, in other examples, the creation 110 of the reduced machine learning model 30 and the distribution 112 of the reduced machine learning model 30 are performed by different apparatus, for example a respective first and second apparatus.

In more detail, referring to FIG. 5, a training round 120 starts with the server apparatus 102 obtaining a machine learning (ML) model 10. For conciseness, training round 120 will be referred to as round 120. This can be an original machine learning model for a first round 120. This can be an updated machine learning model 10 created in the preceding round 120.

The server apparatus 102 creates, from the machine learning (ML) model 10, a reduced machine learning model 30 for example as described previously with reference to FIGS. 3A to 3C.

The reduced machine learning model 30 comprises at least a compressed emulator 32 and an adapter 34. When the reduced machine learning model 30 is trained, the model parameters of the compressed emulator 32 are static and the model parameters of the adapter 34 are updated during training.

The reduced machine learning model 30 can be recreated each round from the current machine learning model 10.

In at least some rounds 120, the reduced machine learning model 30 comprises a first compressed emulator (E1) 32_1, a second compressed emulator (E2) 32_2 and an adapter 34.

In some examples, the server apparatus 102 is configured to generate the first compressed emulator (E1) 32_1 by performing knowledge distillation on the first part 12_1 of the machine learning model 10. For example using the process described with reference to FIG. 4. In some examples, the server apparatus 102 is configured to generate the second compressed emulator (E2) 32_2 by performing knowledge distillation on the second part 12_2 of the machine learning model 10. For example using the process described with reference to FIG. 4. The server apparatus 102 sends the reduced machine learning model 30 to the client apparatus 104. This can, for example, comprise sending (together or separately) to the client apparatus 104 the model parameters that define the first compressed emulator (E1) 32_1 of the reduced machine learning model 30, the model parameters that define the second compressed emulator (E2) 32_2 of the reduced machine learning model 30, and, the model parameters that define the adapter 34 of the reduced machine learning model 30.

The reduced machine learning model 30 is trained at the client apparatus 104.

The reduced machine learning model 30 is configured at the client apparatus 104 so that outputs of the first compressed emulator (E1) 32_1 provide inputs to the adapter 34 and outputs of the adapter 34 provide inputs to the second compressed emulator (E2) 32_2.

The client apparatus 104 trains 114 the reduced machine learning model 30 using training data 50 local to the client apparatus 104 using one or more epochs.

During training of the reduced machine learning model 30 at the client apparatus 104 the first compressed emulator (E1) 32_1 (if present) emulates the first part 12_1 of the machine learning model 10. The first compressed emulator (E1) 32_1 is fixed (not trained). The model parameters of the first compressed emulator (E1) 32_1 are static during training at the client apparatus 104.

During training of the reduced machine learning model 30 at the client apparatus 104, the second compressed emulator (E2) 32_2 (if present) emulates the second part 12_2 of the machine learning model 10. The second compressed emulator (E2) 32_2 is fixed (not trained). The model parameters of the second compressed emulator (E2) 32_2 are static during training at the client apparatus 104.

During training of the reduced machine learning model 30 at the client apparatus 104, the adapter 34 reproduces the third part 12_3 of the machine learning model 10. The adapter 34 is trained (not fixed). The model parameters of the adapter 34 are updated during training at the client apparatus 104.

The training 114, at a client apparatus 104, of the local reduced machine learning model 30 using local training data 50 produces model update parameters 60 that define the adapter 34 after training 114 of the local machine learning model 10.

The model update parameters 60 can, for example, be the model parameters of the trained adapter 34 or can be a difference between the model parameters of the adapter 34 at the start of the training round 120 (before training) and after the training round 120 (after training). For example, if the adapter 34 is a layer of a neural network that has its model parameters locally updated by a client apparatus 104, the model update parameters 60 are, in at least some examples, weighs for the layer, or a difference between weights for the layer pre- and post-training.

In this illustrated example, the training 114 at the client apparatuses 104 is private. The training data 50 used for training at the client apparatus 104 is prevented from being distributed to the server apparatus 102.

The training 114 at the client apparatus 104 can, for example, use unsupervised training (no labels) or use supervised training (explicit labels) or use self-supervised training. Self-supervised training can, for example, apply some transformations to the already available training data 50 to learn some meaningful structure in the data without having access to explicit labels e.g., the concept of a dog in an image does not change if we rotate the image, or if we use grey-scale images, without having access to explicit labels.

The client apparatus 104 provides the model update parameters 60 to the server apparatus 102.

The server apparatus 102 updates 116 the machine learning model 10 based on at least the received model update parameters 60. In some examples the update can take into consideration additional factors such as additional model update parameters. This could, for example, be based on additional model update parameters received from other client apparatuses 104 (e.g. federated learning).

The reduced machine learning model 30 can be recreated each round from the current machine learning model 10 (the machine learning model 10 updated in the previous round). The training process is therefor iterative, round by round.

The adapter 34 can, for example, be changed each round 120.

In at least some examples, the training data 50 used for training 114 is the same across multiple (for example two or more) rounds, for example, until the machine learning model 10 has been fully updated over multiple rounds 120.

The machine learning model 10 is partitioned into parts that define the adapter and compressed emulator(s) of the reduced machine learning model 30. In at least some examples, the partitioning of the machine learning model 10 changes (varies) with each round 120 and consequently the reduced machine learning model 30 changes (varies) with each round. The combination of adapter and compressed emulator(s) that define the reduced machine learning model 30 therefore also change (vary) per round 120.

At a start of each round 120, the machine learning model 10 is varied by a new partitioning. The first part 12_1 (emulated by the first compressed emulator (E1) 32_1), second part 12_2 (emulated by the second compressed emulator (E2) 32_2) and third part 12_3 (reproduced by the adapter 34) are newly defined parts of the machine learning model 10. Consequently the first compressed emulator (E1) 32_1, second compressed emulator (E2) 32_2 and the adapter 34 also change.

The client apparatus 104 therefore receives at the start of each round a new adapter and new compressed emulator(s) that define the newly partitioned and reduced machine learning model 30.

The server apparatus 102 trains (indirectly) the machine learning model 10 by sending to the client apparatus 104 varying versions of: the first compressed emulator (E1) 32_1, the second compressed emulator (E2) 32_2 and the adapter 34.

FIG. 6 extends the example illustrated in FIG. 5 to illustrate a round 120_2 that immediately follows the round 120_1 (previously described as round 120 in FIG. 5).

The server apparatus 102 trains (indirectly) the machine learning model 10 in rounds 120.

The round 120_1 has been described with reference to FIG. 5.

At round 120_2, the server apparatus 102 creates 110 an updated reduced machine learning model 30 comprising:
an updated first compressed emulator (E1) 32_1 configured to emulate an updated first part 12_1 of the machine learning model 10;
an updated second compressed emulator (E2) 32_2 configured to emulate an updated second part 12_2 of the machine learning model 10;
an updated adapter 34 configured to reproduce an updated third part 12_3 of the machine learning model 10.

The updated first compressed emulator (E1) 32_1 is configured to couple (at least some of) its outputs to (at least some of) the inputs of the updated adapter 34 and the updated adapter 34 is configured to couple (at least some of) its outputs to (at least some of) the inputs of the updated second compressed emulator (E2) 32_2.

The server apparatus 102 then sends (together or separately) to the client apparatus 104 at least the updated adapter 34. In some examples, only the updated adapter 34 is transferred because only the adapter 34 has been updated. In other examples the server apparatus 102 then sends (together or separately) to the client apparatus 104 the updated adapter 34 and one or more compressed emulators 32. In this illustrated example, the server apparatus 102 sends (together or separately) to the client apparatus 104 the updated adapter 34, the updated first compressed emulator (E1) 32_1 and the updated second compressed emulator (E2) 32_2.

The client apparatus 104 receives (together or separately), from the server apparatus 102, the updated first compressed emulator (E1) 32_1 configured to emulate an updated first part 12_1 of the machine learning model 10; the updated second compressed emulator (E2) 32_2 configured to emulate an updated second part 12_2 of the machine learning model 10; and the updated adapter 34 configured to reproduce an updated third part 12_3 of the machine learning model 10;

The client apparatus 104 creates an updated local reduced machine learning model 30 by using the updated first compressed emulator (E1) 32_1 to provide inputs to the updated adapter 34 and using the updated adapter 34 to provide inputs to the updated second compressed emulator (E2) 32_2.

The client apparatus 104 performs training 114 of the updated local reduced machine learning model 30 using local training data 50 to obtain additional model update parameters 60 that define the updated adapter 34 after training 114 of the updated local machine learning model 30.

In at least some examples, the training data 50 used for the previous round 120_1 is re-used for this round 120_2.

The client apparatus 104 provides the additional model update parameters 60 to the server apparatus 102.

The server apparatus 102 then receives, from the client apparatus 104, additional model update parameters 60 that define the updated adapter 34 after training 114, at the client apparatus 104, of the updated reduced machine learning model 30

The server apparatus 102 then updates 116 the machine learning model 10 based on the additional model update parameters 60, and the round 120_2 ends.

As a consequence of the change in partitioning of the machine learning model 10 from round 120_1 to round 120_2, the third part 12_3 of the machine learning model 10 at round 120_1 is different to the updated third part 12_3 of the machine learning model 10 at round 120_2. The third part 12_3 of the machine learning model 10 at round 120_1 and the updated third part 12_3 of the machine learning model 10 at round 120_2 are different parts 12 of the machine learning model 10.

The third part 12_3 of the machine learning model 10 at round 120_1 and the updated third part 12_3 of the machine learning model 10 at round 120_2 can, for example be non-overlapping parts 12 of the machine learning model 10.

The third part 12_3 of the machine learning model 10 at round 120_1 and the updated third part 12_3 of the machine learning model 10 at round 120_2 can, for example be contiguous (neighboring) parts 12 of the machine learning model 10. For example, (at least a majority of) outputs of the third part 12_3 of the machine learning model 10 for the round 120_1 provide (at least a majority of) inputs to the updated third part 12_3 of the machine learning model 10 for the next round 120_2.

Thus the adapter 34 for the round 120_1 is associated with a different part 12 of the machine learning model 10 compared to the updated adapter 34 for the next round 120_2.

In some examples, the updated third part 12_3 of the machine learning model 10 for the round 120_2 comprises at least a portion of the second part 12_2 of the machine learning model 10 for the preceding round 120_1.

In some examples, the updated first part 12_1 of the machine learning model 10 for the round 120_2 comprises the first fixed part 12_1 of the machine learning model 10 for the previous round 120_1 and the third part 12_3 of the machine learning model 10 for the previous round.

In some examples, the second part 12_2 of the machine learning model 10 at the round 120_1 consists of, in combination, the third part 12_3 of the machine learning model 10 and the updated second part 12_2 of the machine learning model 10 at the next round 120_2.

In some examples, the first part 12_1 of the machine learning model 10 at the round 120_1 and the updated first part 12_1 of the machine learning model 10 at the round 120_2 are different groups of one or more layers of an ANN; the second part 12_2 of the machine learning model 10 at the round 120_1 and the updated second part 12_2 of the machine learning model 10 at the round 120_2 are different groups of one or more layers of the ANN; and the third part 12_3 of the machine learning model 10 at the round 120_1 and the updated third part 12_3 of the machine learning model 10 at the round 120_2 are different (non-overlapping) groups of one or more layers of the ANN

In at least some examples, for example as illustrated in FIG. 6, the reduced machine learning model 30 is dependent upon a processing capability of the client apparatus 104. In some examples, the reduced machine learning model 30 is varied with varying processing capability of the client apparatus 104.

The processing capability of the client apparatus 104 can for example be based upon the processing resources available at the client apparatus 104 that are available for training a reduced machine learning model 30.

The reduced machine learning model 30 created 110 by the server apparatus 102 is controlled (e.g. partitioned and compressed) to be within the processing capabilities of the client apparatus 104 when being trained 114.

The processing capability or processing resources at the client apparatus 104 can, for example, be based on properties of a controller at the client apparatus 104 including number of millions of instructions processed per second (MIPs), number of processing cores, processing clock speed, memory size and/or speed, graphic processor unit (GPU) acceleration, etc.

For example the number of model parameters used in a compressed emulator 32 for a client apparatus 104 can dependent upon processing capability of the client apparatus 104. For example the size (number of layers or number of model parameters) of the adapter 34 can be dependent upon processing capability of the client apparatus 104.

If the processing capability of the client apparatus 104 is low, then the reduced machine learning model 30 is smaller/simpler and/or the number of model parameters used in the compressed emulator(s) is lower, compared to if the processing capability of the client apparatus 104 is high. That is, in some examples, a reduction in processing capability of the client results in a smaller/simpler reduced machine learning model and/or results in the number of model parameters used in the compressed emulator(s) being reduced. In some example, the processing capability of the client apparatus 104 is low if it is less than a predetermined processing capability and high if it has more than a predetermined processing capability.

The client apparatus 104 can provide a capability indication 132 to the server apparatus 102. In some examples, the capability indication 132 is sent by the client apparatus 104 before the first round 120 and is then used in that round 120 and subsequent rounds to control creation 110 of the reduced machine learning model 30. In the example illustrated, optionally, the capability indication 132 is sent by the client apparatus 104 in a capability response which is sent in reply to a capability request 130 sent to the client apparatus 104 by the server apparatus 102

In some examples, the capability indication 132 is sent by the client apparatus 104 more frequently so that the creation 110 of the reduced machine learning model 30 adapts to variations in processing capability at the client apparatus.

In the example illustrated, optionally, the capability indication 132 is sent by the client apparatus 104 in a capability response during or at the end of the round 120_1 or the start of the round 120_2, so that it is used to control creation 110 of the reduced machine learning model 30 during the round 120_2.

In some examples, the capability indication 132 is sent by the client apparatus 104 along with the model update parameters 60 that define the adapter 34 after training 114 of the reduced machine learning model 30 by the client apparatus 104. In some examples, the capability indication 132 is sent by the client apparatus 104 every time the model update parameters 60 that define the adapter 34 after training 114 of the reduced machine learning model 30 by the client apparatus 104, are sent.

In the example illustrated, the reduced machine learning model 30 (compressed emulator(s) and adapter 34) for the initial round 120_1 is dependent upon a processing capability of the client apparatus 104 sent in the capability indication 132 to the capability request 130 and the reduced machine learning model 30 (compressed emulator(s) and adapter 34) for the next round 120_2 is dependent upon a processing capability of the client apparatus 104 sent between creation 110 of the reduced machine learning model 30 in the initial round 120_1 and the next round 120_2.

It is therefore possible to provide some or all client apparatuses 104 with a bespoke reduced machine learning model 30. The timing or number of rounds 120 may also be dependent upon processing capabilities of the client apparatus 104.

In other examples, a common reduced machine learning model 30 is used that can be processed by all or some of the client apparatuses 102 used. The timing or number of rounds 120 may also be dependent upon processing capabilities of the client apparatus 104 with the lowest processing capability.

This approach can be useful when the client apparatus 104 has a relatively lower processing capability that the server apparatus 102.

This approach can be useful when the client apparatus 104 is a ‘thin’ client or a a hand-held device or personal portable electronic device.

FIG. 7 illustrates an example of the system 100, which can be as previously described.

In this example, a reduced machine learning model 30 created 110 by the server apparatus 102 is sent to client apparatus(es) 104_1 for separate training and a same (or different) reduced machine learning model 30 created 110 by the server apparatus 102 is sent to client apparatus(es) 104_2 for training.

In this example, the training at each of the client apparatuses 104_1, 104_2 is private. The training data 50_1 used for training at the client apparatus 104_1 is prevented from being distributed to the server apparatus 102 or the client apparatus 104_2 (or optionally any other client apparatus 104). The training data 50_2 used for training at the client apparatus 104_2 is prevented from being distributed to the server apparatus 102 or the client apparatus 104_1 (or optionally any other client apparatus 104).

The processes as previously described in relation to FIGS. 5 & 6 occur with respect to the server apparatus 102 and, separately, the client apparatus 104_1 and client apparatus 104_2.

In this example, one reduced machine learning model 30_1 is created 110 by the server apparatus 102 and is sent to client apparatus 104_1 and another, different, reduced machine learning model 30_2 is created 110 by the server apparatus 102 and is sent to client apparatus 104_2 In other examples, a single reduced machine learning model 30 is created 110 by the server apparatus 102 and is sent to multiple client apparatuses 104_1, 104_2 for separate training.

The client apparatus 104_1 performs training 114_2 on the reduced machine learning model (rMLm) 30_1 as previously described, updating the model parameters of the adapter 34 only. The model update parameters 60_1 that define the adapter 34 of the rMLm 30_1 after training 114_1 of the rMLm 30_1 by the client apparatus 104_1, are sent to the server apparatus 102.

Separately, the client apparatus 104_2 performs training 114_2 on the reduced machine learning model (rMLm) 30_2 as previously described, updating the model parameters of the adapter 34 only. The model update parameters 60_2 that define the adapter 34 of the rMLm 30_2 after training 114_2 of the rMLm 30_2 by the client apparatus 104_2, are sent to the server apparatus 102.

Although the training 114_1, 114_2 are illustrated as sequential they can occur in parallel (overlap in time).

The server apparatus 102 then updates 116 the machine learning model 10 using both the model update parameters 60_1 and the model update parameters 60_2. This can be described as an aggregated model update.

In some example, the model update parameters 60_1 and the model update parameters 60_2 are averaged and then applied.

In some examples, a capability indication 132_1 is sent by the client apparatus 104_1 (for example in reply to a capability request 130_1 sent to the client apparatus 104_1 by the server apparatus 102, or sent during a previous round, for example, along with the model update parameters 60). The creation 110 of the rMLm 30_1 can be dependent upon this capability indication 132_1 (as described above).

In some examples, a capability indication 132_2 is sent by the client apparatus 104_2 (for example in reply to a capability request 130_2 sent to the client apparatus 104_2 by the server apparatus 102, or sent during a previous round, for example, along with the model update parameters 60). The creation 110 of the rMLm 30_2 can be dependent upon this a capability indication 132_2 (as described above).

In some examples, the rMLm 30_1 and the rMLm 30_2 can be based on the same first part 12_1, second part 12_2 and third part 12_3 of the machine learning model 10. The adapter 34 of the rMLm 30_1 is the same as the adapter 34 of the rMLm 30_2. In some examples, different compression can be used to produce the first compressed emulator (E1) 32_1 in the rMLm 30_1 and the first compressed emulator (E1) 32_1 in the rMLm 30_2. The compression can, for example, be dependent upon the capability of the respective client apparatuses 104_1, 104_2. In some examples, different compression can be used to produce the second compressed emulator (E2) 32_2 in the rMLm 30_1 and the second compressed emulator (E2) 32_2 in the rMLm 30_2. The compression can, for example, be dependent upon the capability of the respective client apparatuses 104_1, 104_2.

It is therefor possible to provide some or all client apparatuses 104_1, 104_2 with a bespoke reduced machine learning model 30_1, 30_2. The timing or number of rounds 120 for a client apparatus 104_1, 104_2 may also be dependent upon processing capabilities of the client apparatus 104_1, 104_2.

It other examples, a common reduced machine learning model 30 is used that can be processed by all the client apparatuses 104_1, 104_2 used. The timing or number of rounds 120 may also be dependent upon processing capabilities of the client apparatus 104 with the lowest processing capability.

The process of the server apparatus 102 delegating training of a machine learning model 10 to multiple client apparatus 104, which report back updates to the machine learning model 10 after training, that are then aggregated into an update of the machine learning model 10 at the server, can be described as federated learning.

In some examples, the client apparatus 104 determines gradients for its local loss function and reports these to the server apparatus 102. The server apparatus can sum these to obtain gradients for a global loss function and use gradient descent to find the updated model parameters of the machine learning model. This can be described as federated gradient descent.

In some examples, the client apparatus 104 determines gradients for its local loss function and uses gradient descent to find the updated model parameters of the adapter 34 of the local reduced machine learning model 30. The client apparatus then reports the updated local parameters of the updated adapter 34 (as absolute values or as changes) to the server apparatus 102. This can be described as federated averaging.

Thus the server apparatus 102 averages the received updated local parameters of the updated adapters 34, and updates the old adapter 34 with a combination between the old one, and the computed average. If they are layers of a neural network, and the received updated local parameters of the updated adapters 34 are weights (coefficient values), then the server apparatus 102 takes the average of the each weight in the set of weights (coefficient values) across the client apparatus 104_1, 104_2 to create a new set of weights (coefficient values) x_{new} and updates the old set of weights (coefficient values) x_{old} with the new set of weights (coefficient values) x_{new}, for example, computed as x_{new}=A x_{old}+(1-A)x_{average}, where A is a real number between 0 and 1. This is a convex combination of the old values x_{old} and those obtained by the clients x_{new}.

If the clients train different adapters 34, then the process is performed separately for the different adapters 34.

These approaches can be augmented or varied, for example to add dynamic regularization and/or pruning and/or weighted averaging of the updated model parameters rather than simple averaging.

An objective is to converge reduce/minimize the local loss/cost functions at the client apparatuses 104 with reduction/minimization of a global loss objective. This can be achieved by combining local training at multiple client apparatuses 104 with a centralized update.

FIGS. 8A to 8D illustrate the updating of the machine learning model 10 (FIG. 8A) at the server apparatus 102 via remote training rounds 120_1 (FIG. 8B), 120_2 (FIG. 8C), 120_3 (FIG. 8D) at the client apparatus 104

In this example but not necessarily all examples the machine learning model 10 is an ANN comprising layers.

In each round 120_i, the server apparatus 102 splits (partitions) the machine learning model 10 into an adapter part 12_3 and one or more emulator parts 12_1, 12_2 and compresses at least one of the emulator part 12_1, 12_2 to create at least one compressed emulator 32_1, 32_2. The server apparatus 102 then transmits the uncompressed adapter 34 and compressed emulator(s) 32_1, 32_2 to the client apparatus 104. The client apparatus 104 receives the transmitted adapter 34 and the at least one compressed emulator 32_1, 32_2 and then creates and trains the reduced machine learning model 30 keeping the compressed emulator(s) 32_1, 32_2 fixed/frozen while allowing the adapter 34 to be updated. The client apparatus 104 then transmits the trained adapter 34 to the server apparatus 102. The server apparatus 102 receives the trained adapter 34 from the client apparatus 104 and updates the adapter part 12_3 of the machine learning model 10 based on received trained adapter 34.

The first emulator part 12_1 represents the layers that have already been updated by training in previous rounds and are now fixed/frozen for this round and subsequent rounds. The first emulator part 12_1 is not present in the first round 120_1 (FIG. 8B), is layer 1 in the second round 120_2 (FIG. 8C) and is layers 1 to 2 in the third round 120_3 (FIG. 8D) and will be layers 1 to m−1 is the m^{th} round 120_m(not illustrated).

The adapter part 12_3 is the layer being updated by training in the current round 120_i. It is layer 1 in the first round 120_1 (FIG. 8B), layer 2 in the second round 120_2 (FIG. 8C) and layer 3 in the third round 120_3 (FIG. 8D) and will be layer m in round m.

The second emulator part 12_2 represents the layers that have not been updated by training in previous rounds and are not the adapter part 12_3 in the current round 120_i and are temporarily fixed/frozen for this round. The second emulator part 12_2 is layers 2 to N (N=6) in the first round 120_1 (FIG. 8B), is layers 3 to N in the second round 120_2 (FIG. 8C) and is layers 4 to N in the third round 120_3 (FIG. 8D) and will be layers m+1 to N in the m^{th} round 120_m(not illustrated). In the example, the machine learning model 10 has N parts 12 (for example N layers or N blocks).

After N rounds the cycle completes, the whole machine learning model 10 has been updated and the cycle can repeat, for example with new training data 50. In at least some examples, the same training data 50 is re-used in the different rounds 120_i of a cycle so that the whole machine learning model 10 has been updated based on the same training data 50.

The adapter part 12_3 in the previous round (m−1) is added to the end of the first emulator part 12_1 of the previous round (m−1). The adapter part 12_3 in a current round m is taken from the beginning of the second emulator part 12_2 of the previous round (m−1).

Thus in the m^{th} round:
i), the adapter 34 from the previous round (layer m−1) has been added to the end of the first emulator part 12_1 of the previous round. The first emulator part 12_1 is layers 1 to m−2 in the previous round before the addition and is layers 1 to m−1 in the current round after the addition of the layer m−1.
ii) the adapter 34 for the current round (layer m) has been formed from the beginning portion of the second emulator part 12_2 of the previous round.
iii) the second emulator part 12_2 is layers m to N in the previous round and is layers m+1 to N in the current round after the removal of layer m for use as the adapter 34.

Each of FIGS. 8B, 8C, 8D illustrates a different round 120. These FIGS. illustrated that the partitioning of the machine learning model 10 changes (varies) with each round 120 and consequently the reduced machine learning model 30 changes (varies) with each round. The combination of adapter 34 and compressed emulator(s) 32 that define the reduced machine learning model 30 therefore also change (vary) per round 120.

The first compressed emulator (E2) 32_1 is configured to emulate the first emulator part 12_1 of the machine learning model 10 and is fixed in training at the client apparatus 104. The adapter 34 is configured to reproduce the third part 12_3 of the machine learning model 10 and is updated during training at the client apparatus 104. The second compressed emulator (E2) 32_2 is configured to emulate the second part 12_2 of the machine learning model 10 and is fixed in training at the client apparatus 104.

Referring to FIG. 8B, at the start of the first round 120_1, the server apparatus 102 splits (partitions) the machine learning model 10 into an adapter part 12_3 (layer 1) and an emulator part 12_2 (layers 2 to 6) and compresses the emulator part 12_3 to create emulator 32_2. The server apparatus 102 then transmits the uncompressed adapter 34 (layer 1) and second compressed emulator 32_2 to the client apparatus 104. The client apparatus 104 receives the transmitted adapter 34 (layer 1) and the second compressed emulator 32_2 and then creates and trains the reduced machine learning model 30 keeping the compressed emulator 32_2 fixed/frozen while allowing the adapter 34 (layer 1) to be updated. The training uses local training data, with only the adapter 34 (layer 1) being updated. The client apparatus 104 then transmits the trained adapter 34 (layer 1) to the server apparatus 102. The model update parameters 60 that define the adapter 34 (layer 1) after remote training 114 are sent to the server apparatus 102. The server apparatus 102 receives the trained adapter 34 (layer 1) from the client apparatus 104. The server apparatus 102 updates layer 1 of the machine learning model based on received trained adapter 34. The first round 120_1 ends.

Referring to FIG. 8C, at the start of the second round 120_2, the server apparatus 102 splits (partitions) the machine learning model 10 (updated in the previous round) into an adapter part 12_3 (layer 2) and a first emulator part 12_1 (layer 1) and a second emulator part 12_2 (layers 3 to 6) and compresses the second emulator part 12_2 to create the second compressed emulator 32_2 and compresses the first emulator part 12_1 to create the first compressed emulator 32_1 . . . . The server apparatus 102 then transmits the uncompressed adapter 34 (layer 2) and the compressed emulators 32_1, 32_2 to the client apparatus 104. The client apparatus 104 receives the transmitted adapter 34 (layer 2) and the compressed emulators 32_1, 32_2 and then creates and trains the reduced machine learning model 30 keeping the compressed emulators 32_1, 32_2 fixed/frozen while allowing the adapter 34 (layer 2) to be updated. The training uses the same local training data as the previous round, with only the adapter 34 (layer 2) being updated. The client apparatus 104 then transmits the trained adapter 34 (layer 2) to the server apparatus 102. The model update parameters 60 that define the adapter 34 (layer 2) after remote training 114 are sent to the server apparatus 102.

The server apparatus 102 receives the trained adapter 34 (layer 2) from the client apparatus 104. The server apparatus 102 updates layer 2 of the machine learning model 10 based on received trained adapter 34. The second round 120_2 ends.

Referring to FIG. 8D, at the start of the third round 120_3, the server apparatus 102 splits (partitions) the machine learning model 10 (updated in the previous round) into an adapter part 12_3 (layer 3) and a first emulator part 12_1 (layers 1 to 2) and a second emulator part 12_2 (layers 4 to 6) and compresses the second emulator part 12_2 to create the second compressed emulator 32_2 and compresses the first emulator part 12_1 to create the first compressed emulator 32_1. The server apparatus 102 then transmits the uncompressed adapter 34 (layer 3) and the compressed emulators 32_1, 32_2 to the client apparatus 104. The client apparatus 104 receives the transmitted adapter 34 (layer 3) and the compressed emulators 32_1, 32_2 and then creates and trains the reduced machine learning model 30 keeping the compressed emulators 32_1, 32_2 fixed/frozen while allowing the adapter 34 (layer 3) to be updated. The training uses the same local training data as the previous round, with only the adapter 34 (layer 3) being updated. The client apparatus 104 then transmits the trained adapter 34 (layer 3) to the server apparatus 102. The model update parameters 60 that define the adapter 34 (layer 3) after remote training 114 are sent to the server apparatus 102. The server apparatus 102 receives the trained adapter 34 (layer 3) from the client apparatus 104. The server apparatus 102 updates layer 3 of the machine learning model 10 based on received trained adapter 34. The third round 120_3 ends.

This process is repeated round by round. In each successive round, the third part 12_3 (the adapter part) of the machine learning model 10 (after update in the previous round) advances (one layer in this example) through the machine learning model 10. The first part 12_1 (first emulator part) and the second part 12_2 (second emulator part) consequentially change.

In this way the whole of the machine learning model 10 is trained layer by layer (round by round).

In this example, in each successive round, the third part 12_3 defining the adapter 34 advances sequentially (one layer/block at a time in this example) through the machine learning model. The third part 12_3 in a particular round, immediately precedes and is contiguous to the third part 12_3 in the next round.

As the third part 12_3 advances sequentially through the machine learning model 10, part by part, the first part 12_1 (the first emulator part) expands to become the combination of the first part 12_1 and the third part 12_3 of the previous round and the second part 12_2 contracts so that the second part 12_2 and the third part 12_3 in combination is the same as the second part 12_2 in the previous round.

FIGS. 9A and 9B illustrate an extension of the example illustrated in FIGS. 8A to 8D to a system 100 using multiple client apparatus 104. The method as described for FIGS. 8A to 8D occurs separately for each client apparatus 104_1, 104_2 and the update to the machine learning model 10 performed by the server apparatus 102 uses the updated adapters 34 returned, after training, by the client apparatuses 104_1, 104_2.

In at least some examples, the training at the first client apparatus 104_1 uses training data that is private to that first client apparatus 104_1 and the training at the second client apparatus 104_2 uses training data that is private to that second client apparatus 104_2. In FIG. 9A a common reduced machine learning model (rMLm) 30 is trained separately at the first client apparatus 104_1 and at the second client apparatus 104_2. The common reduced machine learning model (rMLm) 30 has an adapter 34 formed from the adapter part 12_3 of the machine learning model 10. The client apparatuses 104 train the same rMLm 30 using different training data and return the updated adapters 34 to the server apparatus 102 which updates the machine learning model 10.

In FIG. 9B a first reduced machine learning model (rMLm) 30_1 is trained separately at the first client apparatus 104_1 and a second reduced machine learning model (rMLm) 30_2 is trained separately at the second client apparatus 104_2. The first reduced machine learning model (rMLm) 30_1 and the second reduced machine learning model (rMLm) 30_2 are different. In the example illustrated the first reduced machine learning model (rMLm) 30_1 and the second reduced machine learning model (rMLm) 30_2 are different because they have different adapters 34 (different adapter parts 12_3 of the machine learning model 10). In other examples the first reduced machine learning model (rMLm) 30_1 and the second reduced machine learning model (rMLm) 30_2 are different because they have the same adapter 34 (same adapter part 12_3 of the machine learning model 10) but have different compressed emulators 32 representing the same parts of the machine learning model. This may be because a different compression is performed for a compressed emulator 32 used at the first client apparatus 104_1 compared to compression performed for a compressed emulator 32 used at the second client apparatus 104_2. The different compression can, for example, be controlled in dependence upon different processing capabilities of the client apparatus 104, as previously described.

In at least some examples, the variation in the partitioning of the machine learning model 10 to define the adapter 34 is performed according to an automated schedule.

In the example illustrated the machine learning model 10 has N parts 12 (for example N layers or N blocks). In each round the third part 12_3 is a different one of the parts 12 (a different one of the N layers or a different one of the N blocks). In this example, but not necessarily all examples, each part 12 (for example, each layer or each block) of the machine learning model 10 is used as a third part 12_3 with the same average frequency. In this example, but not necessarily all examples, the parts (for example, the layers or blocks) are used in sequential order as the third part 12_3 in successive rounds.

The schedule can, for example, be a data structure that specifies which parts 12 are to be used as the adapter 34 in successive rounds. In the example illustrated the schedule would specify (layer 1, layer 2, layer 3, layer 4, layer 5, layer 6). This schedule can repeat in cycles. However other schedules could be used, such as for example (layer 1, layer 3, layer 5, layer 2, layer 4, layer 6) or other orders are possible.

The server apparatus 102 is therefore configured to separately train 114 each of a series of different adapters 34 wherein each adapter 34 in the series of different adapters 34 is a different adapter part 12_3 of a machine learning model 10. This comprises: selecting an adapter 34 from the series of different adapters 34 for remote training 114; generating at least one compressed emulator 32 configured to emulate a part 12_1, 12_2 of the machine learning model 10 which is coupled to the selected adapter 34; sending to the client the at least one compressed emulator 32_1, 32_2 and the selected adapter 34 as a reduced machine learning model 30 based on the selected adapter 34; and receiving, from the client, model update parameters 60 that define the selected adapter 34 after remote training 114, at the client apparatus 104, of the reduced machine learning model 30 based on the selected adapter 34; updating the machine learning model 10 comprising updating the adapter part 12_3 of the machine learning model 10 (the selected adapter 34) using the model update parameters 60.

In at least some examples, this updating of the machine learning model 10 does not comprise updating the parts of the machine learning model 10 other than the adapter part 12_3. The parts of the machine learning model 10 other than the adapter part 12_3 are fixed (not remote trained). Updating the machine learning model 10 consists of updating only the adapter part 12_3 of the machine learning model 10.

The first part 12_1 of the machine learning model 10 and the adapter part 12 of the machine learning model 10 (the adapter 34) are combined to create, for the next training round 120, a first part 12_1 of the machine learning model 10.

A portion of the second part 12_2 of the machine learning model 10 adjacent the adapter part 12 of the machine learning model 10 creates, for the next training 114 round 120, the adapter part 12 of the machine learning model 10.

Thus, for a training round 120, the adapter part 12_3 of the machine learning model 10 for a round 120, comprises at least a leading portion of the second part 12_2 of the machine learning model 10 for the previous training round 120.

As previously described. the same local training data 50 can be used at a client apparatus 104 for a plurality of training epochs in a training round 120, before providing the model update parameters 60 to the server once per training round 120.

In at least some examples, the client apparatus 104 is configured to determine the output of the first compressed emulator (E1) 32_1 based on the local training data 50 for a first epoch of the training round 120 and to then re-use the output of the first compressed emulator (E1) 32_1, without redetermination, in subsequent epochs of the training round 120. After determining the output of the first compressed emulator (E1) 32_1 based on the local training data 50 for a first epoch of the training 114 round 120, that output is stored in a memory. The stored output is then accessed and re-used as the output of the first compressed emulator (E1) 32_1 in subsequent epochs of the round. The output of the first compressed emulator (E1) 32_1 is therefore determined once per round in the first epoch and then reused in subsequent epochs of that round 120. This is possible because the first compressed emulator (E1) 32_1 is fixed (not updated).

As the compressed emulators 32_1, 32_2 are fixed through the round 120 and are not updated at any iteration within the round 120, then only the adapter 34 is updated at each iteration of the round 120.

A consequence of this is that, if back-propagation is used, the back-propagation only needs to be continued backwards through the second compressed emulator 32_2 to include the adapter 34. The back-propagation does not need to be continued backwards through beyond the adapter 34. The client apparatus 104 does not therefore need to train the whole of the reduced machine learning model 30. It only needs to update the adaptor 34.

There is clearly a benefit to calculating inputs to the adapter 34 once in a training round 120.

Some advantage can also arise from using a sequential schedules e.g. (layer 1, layer 2, layer 3 . . . )

FIG. 10A illustrates an example of the system 100 as described with reference to FIGS. 8A to 8D, in which the adapter advances sequentially, part-by-part (layer-by-layer) through the model 10.

In some, but not necessarily all examples, the sequential advancement of the adapter 34, part-by-part 12 (for example, layer by layer in an artificial neural network), has certain advantages at the client apparatus 104 when the same training data is used in successive rounds 120.

In at least some examples, as illustrated in FIG. 10A, the output of a trained adapter 34, in a current round 120_i, is saved for use in the next round 120_i+1. The saved output of the trained adapter 34, for the immediately preceding round 120_i−1, is used 200 as the input to the adapter 34 in the current round 120_i.

Thus the client apparatus 104 is configured to determine and store the output of the trained adapter 34, based on the local training data 50, for the last epoch of a m^{th} training round 120 and to then use 200 that stored output of the trained adapter 34 (m^{th} training round), without redetermination, in the next round ((m+1)th round) as an input to the updatable adapter 34 of that round ((m+1)th round).

As a consequence, it is not necessary to create the first compressed emulator 32_1 at the server apparatus 102 and it is not necessary to transfer the first compressed emulator 32_1 to the client apparatus 104.

This approach is suitable when the third part 12_3 of the machine learning model 10 updated by the server apparatus 102 is only updated in dependence upon the client apparatus 104, such that the client apparatus 104 knows that its local adapter 34 represents the updated third part 12_3 of the machine learning model 10. This information may be communicated to the client apparatus 104 by the server apparatus 102.

This approach may not be suitable when the third part 12_3 of the machine learning model 10 updated by the server apparatus 102 is updated in dependence upon multiple client apparatuses 104, such that no client apparatus 104 knows the recent server-updated third part 12_3 of the machine learning model 10.

In this (federated) example, as illustrated in FIG. 10B, the input to the adapter 34, in a current round 120_i, is saved for use 202 in the next round 120_i+1. The saved input of the adapter 34, for the immediately receding round 120_i−1, is used 202 as the input to updated part of the model corresponding to the adapter of the preceding round 120_i−1.

Thus in the second round 120_2, the output from layer 1 (L1) is stored for use 202 in the next round. The adapter 34 corresponds to layer 2 (L2), hence, the trained version is communicated to the server apparatus 102 which performs a federated update to layer 2 (L2).

In the third round, the server apparatus 102 provides the updated layer 2 (L2), the adapter 34 (A) and the second compressed emulator 32_2 (E2) to the client apparatus 104. The adapter 34 is layer 3 (L3). The second compressed emulator 32_2 is a compressed version of layers 4 to 6. The stored output from layer 1 (L1), which was stored in the previous round, is provided 202 as an input to the updated layer 2 (L2) received from the server apparatus 102. The output from layer 2 (L2) is provided to the adapter 34 (L3). The output from layer 2 is stored for use in the next round 120_4. The trained version of the adapter 34 (L3) is communicated to the server apparatus 102 which performs a federated update to layer 3 (L3).

In the fourth round, the server apparatus 102 provides the updated layer 3 (L3), the adapter 34 (A) and the second compressed emulator 32_2 (E2) to the client apparatus 104. The adapter 34 is layer 4 (L4). The second compressed emulator 32_2 is a compressed version of layers 5 to 6. The stored output from layer 2 (L2), which was stored in the previous round, is provided 202 as an input to the updated layer 3 (L3) received from the server apparatus 102. The output from layer 3 (L3) is provided to the adapter 34 (L4). The output from layer 3 (L3) is stored for use in the next round (not illustrated). The trained version of the adapter 34 (L4) is communicated to the server apparatus 102 which performs a federated update to layer 4 (L4).

As a consequence, it is not necessary to create the first compressed emulator 32_1 at the server apparatus 102 and it is not necessary to transfer the first compressed emulator 32_1 to the client apparatus 104. Instead, only that part of the machine learning model 10 that has been updated is transferred.

Thus using a sequential schedule can allow a reduced number of calculations to calculate the inputs to the adapter 34. Using this approach also reduces the communication overhead.

In the above example, the third parts 12_3 (the adapter parts) of the machine learning model 10 are contiguous in successive training rounds 120. In the examples described, the index/block/layer number of the adapter could be (round 1=block/layer 1, round 2=block/layer 2, round 3=block/layer 3, etc.)

This approach has the advantage that the server does not have to transmit a full first emulator (e.g. reproducing behaviour of: blocks 1->adapter block−1). Instead it only needs to transmit a partial emulator (i.e. the (updated) blocks used for the adapter in the previous round), therefore reducing communication resources. The client apparatus 104 doing the training can also use “saved activations” from part-way through the machine learning model (reducing the amount of computations on the client apparatus 104).

This approach has applications to other training routines and the contiguous adapter position in successive training rounds is not an essential requirement.

Considering, the following adapter position schedule: (round 1=block/layer 1, round 2=block/layer 4, round 3=block/layer 8). The same approach can still be used (transmitting only a partial emulator).

In round 3, the adapter position is block/layer 8 and in the immediately preceding round 120, round 2, the adapter position is block/layer 4.

In a current round, the partial emulator transmitted is the adapter block updated in the previous round and any intervening (frozen) blocks between (and not including) the adapter position in the previous round 120 and the adapter position in the current round. For example, in round 3, the partial emulator transmitted is the adapter block (e.g. block/layer 4) updated in the previous round (e.g. block 4) and any intervening (frozen) blocks (e.g. block/layer 5 to block/layer 7) between (and not including) the adapter position (e.g. block/layer 4) in the previous round 120 (round 2) and the adapter position (e.g. block/layer 8) in the current round (round 3).

Advantages can then be achieved by having an index/block/layer number of the adapter that increase each training round (consecutive increasing index/block/layer by index/block/layer is not necessary in all examples)

Let us consider the following use case.

A large generalized machine learning model 10, for example a large language model, updated on various different application-specific datasets to create different application specific model. The machine learning model 10 is called a foundation models (FM) because of its generalization abilities. Sources of public data for training the machine learning model to create a foundation model are limited. It would be desirable to use data generated by users while using their personal devices, e.g., smartphones, smartwatches, earbuds, etc., without affecting their privacy or draining their batteries

A large generalized machine learning model 10 exists in a server apparatus 102 and it is desired to access more training data to improve it while maintaining the machine learning model 10 as a generalized model (as opposed to creating an application specific model). The end-result desired is an improved generalizable machine learning model 10.

The system 100 makes use of users' local data as training data 50 for private training but the ultimate goal is not to improve the local models. The system 100 uses a global update at the server apparatus 102 for scale and consolidation, and local training 114 at the client apparatuses for data diversity.

The system 100 uses distributed and privacy-preserving training 114 which works in rounds 120. At each round 120, the users' devices train a shared rMLm 30 using local private data as training data 50. The local training 14 updates the adapter 34 of the local rMLm 30.

The machine learning model 10 is locally trained as a reduced machine learning model 30 where one or more compressed emulators 32 are kept fixed (“frozen”) to reduce the training 114 overhead. Only the adapter 34 is updated during the local training 114.

These features allow the reduced machine learning model 30 to be trained or used for inference on a user device, when it may be impossible or impractical to use the machine learning model 10.

At the end of each local round 120, each user client apparatus 104 uploads the model update parameters 60 that define the adapter 34 after training 114 of the local rMLm 30 (e.g. gradients).

With federated gradient descent (FGD), gradient is computed locally by multiple client apparatuses 104 and communicated to the server apparatus 102. With federated averaging, is a specific (baseline) for FGD in which the aggregation at the server side happens by averaging the gradients from the clients. Versions differ by how local optimization is performed, and how updates (gradients or weights) are communicated to the server apparatus 102 (and vice versa), and by how they are aggregated

The server apparatus 102 aggregates the model update parameters 60 from multiple client apparatuses into a new global ML model 10. Then, the updated global model 10 is used to generate a new rMLm 30 which is communicated to the users' client apparatuses 104 to start a new training round 120. The training data 50 never leaves the user's client apparatus 104 because training 114 using the training data 50 is performed locally.

In more detail, the server apparatus 102 initializes a new training round 120 by extracting a third part 12_3 (a specific module), the adapter 34, and reduces the remaining parts 12_1, 12_2 of an ANN using compression techniques. Those parts 12_1, 12_2 after compression are called emulators 32_1, 32_2, and are kept frozen/fixed locally during training 114, and are not updated by the clients 104, which only train the adapter 34.

Then, the clients 104 send back to the server apparatus 102 only the updated adapters 34, which are then aggregated by the server apparatus 102 to output a new global model 10. During the subsequent training rounds 120, other third parts 12_3 (e.g. modules/blocks/layers) are selected as adapters 34 and are trained locally at the clients 104, obtaining at the end a fully updated foundation model 10.

In the following example, the machine learning model 10 is an ANN with arbitrary number of layers and architectures, but in some examples, a large foundation model comprises multiple layers of attention/transformer and/or convolutional, dense/linear layers.

At the beginning of the first round 120, an untrained or pre-trained model 10 is located on the server apparatus 102.

In the case of the pre-trained model 10, the original training dataset might be either stored on the server apparatus 102 or be unavailable. This dataset is considered private and cannot be shared with the local client apparatus 104 (e.g., smartphones).

A partition of the server dataset will be used to evaluate the model 10 in the final step, to assess whether the federated training 114 has improved the foundation model.

The server apparatus 102 generates 110 a reduced machine learning model (rMLm) 30 from the machine learning model 10. Assuming that the machine learning model 10 is a deep neural network, the server apparatus 102 generating 110 a reduced machine learning model (rMLm) 30 selects a layer (or sets of layers) as a third part 12_3 (an adapter part) to form the adapter 34. Different adapters 34 are chosen for different rounds 120.

The first adapter 34 is chosen at the beginning of the first round 120, then the second adapter 34 in the second round 120, and so on until passing through the whole model 10 once before going back to the first adapter 34. This way, local clients 104 can further minimize the number of local computations (during a round 120) by computing the input to the adapter 34 (i.e., hidden representations) only once (for the first epoch of the round 120), and use such representations during training 114 (during subsequent epochs of the round 120).

The adapter 34 is the only part 12 of the artificial neural network that is sent to the local device as a trainable block. A first part 12_1 (a first block) precedes the adapter 34 and a second part 12_2 (a second block) follows the adapter 34. The first block 12_1 and the second block 12_2 are replaced in the reduced machine learning model (rMLm) 30 by a first compressed emulator (E1) 32_1 and a second compressed emulator (E2) 32_2 respectively to reduce the overall size of the network.

The first compressed emulator (E1) 32_1 and the second compressed emulator (E2) 32_2 are kept fixed (“frozen”) to reduce the training 114 overhead.

The compressed model, the rMLm 30, with the trainable adapter 34 is transferred 112 to the local client apparatus 104, where it is trained using the local training data 50. Annotations or labels from the user is not required if the training 114 follows the self-supervised learning protocol. In some examples, contrastive learning with Siamese ANN is used. A Siamese ANN is a class of ANN architectures that contain two or more identical sub-networks with the same configuration and the same model parameters e.g. weights. Only the adapter 34 is updated during the training 114 process while the emulators 32 are fixed. In this example, training occurs for at least two epochs per round 120. The number of epochs used can be identified on a dataset-by-dataset basis (for the training data 50).

After local training 114 at the client apparatus 104, the newly trained adapter 34 is sent back to the server apparatus 102 to be integrated 116 into the original model 10, according to the federated learning protocol. It is sent as model update parameters 60. This occurs for multiple client apparatuses 104. In this step, other local clients 104 (at least two) have trained independent adapters 34 that will all be sent to the server apparatus 102 in parallel.

The server apparatus 102 performs federated averaging (FedAvg) by combining all the model update parameters 60 from different clients 104 and replacing the original adapter 34 of the machine learning model 10. This averaging process ensures that the global model 10 benefits from the knowledge learned on different clients 104 while preserving privacy. Last, the impact of the federated training 114 is assessed on the held-out dataset that decides whether the process will continue (e.g. using at least five rounds 120 and an early-stopping policy).

After a complete federated round 120, the server apparatus 102 picks a new block as the new adapter 34 and commences the new round 120 by generating 110 a new rMLm 30.

The system 100 was tested in Python using the PyTorch and Flower libraries, using a large ResNet_18 model of almost 12 million parameters for the machine learning model 10. This model is of such a size that it cannot be run on constrained devices such as smartphones, therefore motivating the parameter-efficient distributed method. FIG. 2B illustrates an example of a Resnet_10 machine learning model 10.

Using benchmark image recognition dataset CIFAR_100 distributed to 5 client apparatus 104 without data overlap between clients 104, performance (accuracy) was evaluated on the held-out test set using a kNN classifier applied to the learned representations of the updated model.

Different numbers of training epochs per round were trialed. The number of local training 114 epochs (per round 120) can impact the quality of the machine learning model 10.

As illustrated in FIG. 11A, the machine learning model 10 improves accuracy with increasing rounds 120. Compared to a static pre-trained model, the more we train locally and the more updates we send back to the central model (the more rounds 120), the better the model performs. With higher numbers of local epochs, the model learns better representations of the local data. This shows that the strategy is particularly data-efficient because it just requires more training steps with the same amounts of data or number of parameters.

In at least some examples, the server apparatus 102 and or the client apparatus 104 is configured to vary the number of epochs per training round 120. In some example, the server apparatus 102 provides a constraint as to a minimum and/or a maximum number of training epochs per round. The client apparatus 104 then uses a number of epochs within the constrained range.

In at least some examples, the client apparatus 104 generates a performance measure and stops training once a target performance has been reached. Thus the number of epochs per round varies. The target performance can for example be communicated by the server apparatus 102.

The accuracy performance increases with increasing numbers of epochs per round and increasing numbers of rounds.

Different sizes (number of layers) of adapters 34 were trialed. A third part 12_3 (also referred to as adapter part 12_3 or module 12_3) is comprised of one residual block and each residual block has two layers.

The trialed adapter 34 sizes include 10× smaller and 20× smaller. As illustrated in FIG. 11B, there is minimal performance drop when the adapter is 1/10^{th} the size of the machine learning model 10. Therefore processing and communication overhead are reduced with little reduction in performance.

When the adapter is 1/10^{th} the size of the machine learning model 10 (compared to the machine learning model 10) there is:
a 44% reduction in the number of model parameters;
a 95% reduction in upload communication to the server apparatus 102 from the client apparatus 104;
a 72% reduction in the download communication from the server apparatus 102 to the client apparatus 104.

Note that despite including the full model 10 in the trial, such a model cannot realistically run on a personal device.

A machine learning model 10 can be trained on unique telecommunications-related textual and multimodal data. Then, it can be securely shipped to client apparatus 104 to learn from additional data private to those client apparatuses 104. The gains are two-fold: an improved centralized model 10 with more diverse data and users benefit from a model 10 that has been trained broadly in a privacy-preserving manner.

The above described example methods are particularly adapted for the implementation in that the design is motivated by technical considerations of the internal functioning of the system or network e.g. compression of emulators, transfer and storage and processing of compressed emulators. The examples are designed to exploit particular technical properties of the technical system on which they are implemented to bring about a technical effect such as efficient use of computer storage capacity, network bandwidth, power consumption

The methods also assign the execution of data-intensive training of a machine-learning algorithm to clients and preparatory steps to a server to take advantage of a server-client architecture.

The training data and the training of the reduced machine learning model is technical in that there is distributed training across multiple clients and the training data at each client is secured and remains private.

The machine learning model 10 can find application in many fields of technology. For example:
classification of digital images, videos, audio, or speech signals based on low-level features (e.g. edges or pixel attributes for images).
controlling a technical system or process, e.g. a computer-controlled classification system or industrial process
determining from measurements a adaptation to an industrial process;
digital audio, image or video enhancement or analysis,
separation of sources in speech signals; speech recognition,
encoding data for reliable and/or efficient transmission or storage (and corresponding decoding); compression of audio, image, video or sensor data;
encrypting/decrypting or signing electronic communications;
determining a technical parameter (e.g. energy expenditure, core temperature) by processing data obtained from sensors;
providing a reliability estimate for technical information e.g. a genotype
providing a medical diagnosis by an automated system processing physiological measurements.
deriving or predicting a physical state of an existing real object from measurements of physical properties
causally linking sensor data provided as inputs to the ML model to control command outputs for controlling apparatus provided as outputs of the ML model.

FIG. 12 illustrates an example of a controller 400 suitable for use in an apparatus. The apparatus can be the server apparatus 102. The apparatus can be the client apparatus 104. Implementation of a controller 400 may be as controller circuitry. The controller 400 may be implemented in hardware alone, have certain aspects in software including firmware alone or can be a combination of hardware and software (including firmware).

As illustrated in FIG. 12 the controller 400 may be implemented using instructions that enable hardware functionality, for example, by using executable instructions of a computer program 406 in a general-purpose or special-purpose processor 402 that may be stored on a computer readable storage medium (disk, memory etc) to be executed by such a processor 402.

The processor 402 is configured to read from and write to the memory 404. The processor 402 may also comprise an output interface via which data and/or commands are output by the processor 402 and an input interface via which data and/or commands are input to the processor 402.

The memory 404 stores a computer program 406 comprising computer program instructions (computer program code) that controls the operation of an apparatus when loaded into the processor 402. The computer program instructions, of the computer program 406, provide the logic and routines that enables the apparatus to perform the methods illustrated in the accompanying FIGS. The processor 402 by reading the memory 404 is able to load and execute the computer program 406.

The (client) apparatus 104 comprises:
at least one processor 402; and
at least one memory 404 including computer program code,
the at least one memory storing instructions that, when executed by the at least one processor 402, cause the apparatus at least to:
   receive, from the server, a second compressed emulator configured to emulate a second fixed part of the machine learning model;
   receive, from the server, an adapter configured to reproduce a third trainable part of the machine learning model, wherein the third trainable part is intermediate the first part and the second part;
   create a local reduced machine learning model by using the adapter to provide inputs to the second compressed emulator;
   perform training of the local reduced machine learning model using local training data to obtain model update parameters that define the adapter after training of the local machine learning model; and
   provide the model update parameters to the server.

The (server) apparatus 102 comprises:
at least one processor 402; and
at least one memory 404 including computer program code,
the at least one memory storing instructions that, when executed by the at least one processor 402, cause the apparatus at least to:
create a reduced machine learning model comprising:
   a second compressed emulator configured to emulate a second fixed part of the machine learning model;
   an adapter configured to reproduce a third trainable part of the machine learning model,
   wherein the adapter is configured to provide inputs to the second compressed emulator;
send to the client the second compressed emulator;
send to the client the adapter; and
receive, from the client, model update parameters that define the adapter after training, at the client, of the reduced machine learning model.

As illustrated in FIG. 13, the computer program 406 may arrive at the apparatus 102, 104 via any suitable delivery mechanism 408. The delivery mechanism 408 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 406. The delivery mechanism may be a signal configured to reliably transfer the computer program 406. The apparatus may propagate or transmit the computer program 406 as a computer data signal.

Computer program instructions for causing a (server) apparatus 102 to perform at least the following or for performing at least the following:
creating a reduced machine learning model comprising:
   a second compressed emulator configured to emulate a second fixed part of the machine learning model;
   an adapter configured to reproduce a third trainable part of the machine learning model,
      wherein the adapter is configured to provide inputs to the second compressed emulator;
sending to the client the second compressed emulator;
sending to the client the adapter; and
receiving, from the client, model update parameters that define the adapter after training, at the client, of the reduced machine learning model.

Computer program instructions for causing a (client) apparatus 104 to perform at least the following or for performing at least the following:
receiving, from the server, a second compressed emulator configured to emulate a second fixed part of the machine learning model;
receiving, from the server, an adapter configured to reproduce a third trainable part of the machine learning model, wherein the third trainable part is intermediate the first part and the second part;
creating a local reduced machine learning model by using the adapter to provide inputs to the second compressed emulator;
performing training of the local reduced machine learning model using local training data to obtain model update parameters that define the adapter after training of the local machine learning model; and
providing the model update parameters to the server.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/dynamic/cached storage.

Although the processor 402 is illustrated as a single component/circuitry it may be implemented as one or more separate components/circuitry some or all of which may be integrated/removable. The processor 402 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The method blocks illustrated in the accompanying FIGS. may represent steps in a method and/or sections of code in the computer program 406. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

The systems, apparatus, methods and computer programs may use machine learning which can include statistical learning. Machine learning is a field of computer science that gives computers the ability to learn without being explicitly programmed. The computer learns from experience E with respect to some class of tasks T and performance measure P if its performance at tasks in T, as measured by P, improves with experience E. The computer can often learn from prior training data 50 to make predictions on future data. Machine learning includes wholly or partially supervised learning and wholly or partially unsupervised learning. It may enable discrete outputs (for example classification, clustering) and continuous outputs (for example regression). Machine learning may for example be implemented using different approaches such as cost function minimization, artificial neural networks, support vector machines and Bayesian networks for example. Cost function minimization may, for example, be used in linear and polynomial regression and K-means clustering. Artificial neural networks, for example with one or more hidden layers, model complex relationship between input vectors and output vectors. Support vector machines may be used for supervised learning. A Bayesian network is a directed acyclic graph that represents the conditional independence of a number of random variables.

As used here ‘hardware module’ refers to a unit or apparatus that excludes certain parts/components that would be added by an end manufacturer or a user. The client apparatus 104 can be a hardware module.

The above-described examples find application as enabling components of:
automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1.-17. (canceled)

18. An apparatus comprising:
at least one processor; and
at least one memory storing instructions that, when executed by the at least one processor, cause the apparatus at least to:
create a reduced machine learning model comprising:
a second compressed emulator configured to emulate a second fixed part of a machine learning model;
an adapter configured to reproduce a third trainable part of the machine learning model,
wherein the adapter is configured to provide inputs to the second compressed emulator;
send to a client the second compressed emulator;
send to the client the adapter; and
receive, from the client, model update parameters that define the adapter after training, at the client, of the reduced machine learning model.

19. The apparatus as claimed in claim 18, wherein the created reduced machine learning model additionally comprises a first compressed emulator configured to emulate a first fixed part of the machine learning model, wherein the first compressed emulator is configured to provide inputs to the adapter; and wherein the apparatus is further caused to: send to the client the first compressed emulator.

20. The apparatus as claimed in claim 19, wherein the apparatus is further caused to:
train the machine learning model by sending varying versions of: the first compressed emulator, the second compressed emulator and the adapter.

21. The apparatus as claimed in claim 20, wherein the training of the machine learning model further comprises:
vary the first fixed part emulated by the first compressed emulator, the second fixed part emulated by the second compressed emulator (E2) and the third trainable part reproduced by the adapter.

22. The apparatus as claimed in claim 20, wherein the training of the machine learning model further comprises:
create an updated reduced machine learning model comprising:
an updated first compressed emulator configured to emulate an updated first part of the machine learning model;
an updated second compressed emulator configured to emulate an updated second part of the machine learning model;
an updated adapter configured to reproduce an updated third part of the machine learning model;
wherein the updated first compressed emulator is configured to provide inputs to the updated adapter and the updated adapter is configured to provide inputs to the updated second compressed emulator;
send to the client at least the updated adapter;
receive, from the client, additional model update parameters that define the updated adapter after training, at the client, of the updated reduced machine learning model; and
update the machine learning model based on the additional model update parameters.

23. The apparatus as claimed in claim 22, wherein:
the third trainable part of the machine learning model is different to the updated third part of the machine learning model.

24. The apparatus as claimed in claim 23, wherein:
the updated first part of the machine learning model comprises the first fixed part of the machine learning model and the third trainable part of the machine learning model.

25. The apparatus according to claim 18, wherein the apparatus is further caused to:
send to a second client the first compressed emulator;
send to the second client the second compressed emulator;
send to the second client the adapter;
receive, from the second client, model update parameters that define the adapter after training, at the second client, of the reduced machine learning model; and
perform an update to the machine learning model using the model update parameters that define the adapter after training at the client, and using the model update parameters that define the adapter after training at the second client.

26. The apparatus according to claim 18, wherein the apparatus is further caused to:
create a second reduced machine learning model for a first client, comprising:
a third compressed emulator configured to emulate a fourth part of the machine learning model;
a fourth compressed emulator configured to emulate a fifth part of the machine learning model;
a second adapter configured to reproduce a sixth part of the machine learning model; wherein at least one of: the first, second or third parts of the machine learning model is different to the fourth, fifth, or sixth parts respectively of the machine learning model; and wherein:
the third compressed emulator is configured to provide inputs to the second adapter and the second adapter is configured to provide inputs to the fourth compressed emulator; and
send to the first client the third compressed emulator, the fourth compressed emulator and the second adapter.

27. An apparatus comprising
at least one processor; and
at least one memory storing instructions that, when executed by the at least one processor, cause the apparatus at least to:
receive, from a server, a second compressed emulator configured to emulate a second fixed part of a machine learning model;
receive, from the server, an adapter configured to reproduce a third trainable part of the machine learning model, wherein the third trainable part is intermediate a first fixed part and the second fixed part of the machine learning model;
create a local reduced machine learning model by using the adapter to provide inputs to the second compressed emulator;
perform a training of the local reduced machine learning model using local training data to obtain model update parameters that define the adapter after training of the local machine learning model; and
provide the model update parameters to the server.

28. The apparatus as claimed in claim 27, wherein the apparatus is further caused to:
receive, from the server, a first compressed emulator configured to emulate the first fixed part of the machine learning model; and
wherein the creating of the local reduced machine learning model uses the first compressed emulator to provide inputs to the adapter.

29. The apparatus according to claim 28, wherein the apparatus is further caused to:
train machine learning model by receiving varying versions of: the first compressed emulator, the second compressed emulator and the adapter to be trained by the apparatus.

30. The apparatus according to claim 29, wherein the training of the machine learning model further comprises:
receive, from the server, an updated first compressed emulator configured to emulate an updated first part of the machine learning model;
receive, from the server, an updated second compressed emulator configured to emulate an updated second part of the machine learning model;
receive, from the server, an updated adapter configured to reproduce an updated third part of the machine learning model;
create an updated local reduced machine learning model by using the updated first compressed emulator to provide inputs to the updated adapter and using the updated adapter to provide inputs to the updated second compressed emulator;
perform a training of the updated local reduced machine learning model using local training data to obtain additional model update parameters that define the updated adapter after training of the updated local machine learning model; and
provide the additional model update parameters to the server.

31. The apparatus as claimed in claim 30, wherein:
the third trainable part of the machine learning model is different to the updated third part of the machine learning model.

32. The apparatus as claimed in claim 31, wherein:
the updated first part of the machine learning model comprises the first fixed part of the machine learning model and the third trainable part of the machine learning model.

33. The apparatus according to claim 27, further caused to use same local training data for a plurality of training epochs in a training round, before providing the model update parameters to the server once per training round.

34. The apparatus as claimed in claim 33, further caused to determine the output of the first compressed emulator based on the local training data for a first epoch of the training round and to re-use the output of the first compressed emulator, without redetermination, in subsequent epochs of the training round.

35. A method comprising:
creating a reduced machine learning model comprising:
a second compressed emulator configured to emulate a second fixed part of the machine learning model;
an adapter configured to reproduce a third trainable part of the machine learning model,
wherein the adapter is configured to provide inputs to the second compressed emulator;
sending to the client the second compressed emulator;
sending to the client the adapter; and
receiving, from the client, model update parameters that define the adapter after training, at the client, of the reduced machine learning model.

36. The method as claimed in claim 35, wherein the created reduced machine learning model additionally comprises a first compressed emulator configured to emulate a first fixed part of the machine learning model, wherein the first compressed emulator is configured to provide inputs to the adapter; and wherein the method further comprises:
sending, to the client, the first compressed emulator.

37. The method as claimed in claim 36, further comprising:
training the machine learning model by sending varying versions of: the first compressed emulator, the second compressed emulator and the adapter.
